(19) United States
(12) Patent Application Publication
(10) Pub. No.: US 2015/0073871 A1
(43) Pub. Date: Mar. 12, 2015

(54) PROVIDING TREND DATA FOR PRODUCT CONTENT

(71) Applicants: Yu Ping Hu, Mountain View, CA (US); Vinod R. Marur, Palo Alto, CA (US); Gaurav R. Bhaya, Sunnyvale, CA (US); Suresh K. Batchu, Sunnyvale, CA (US); Rudolf Cornelis Maria de Rooij, Sunnyvale, CA (US)

(72) Inventors: Yu Ping Hu, Mountain View, CA (US); Vinod R. Marur, Palo Alto, CA (US); Gaurav R. Bhaya, Sunnyvale, CA (US); Suresh K. Batchu, Sunnyvale, CA (US); Rudolf Cornelis Maria de Rooij, Sunnyvale, CA (US)

(73) Assignee: Google Inc.

(21) Appl. No.: 13/419,266

(22) Filed: Mar. 13, 2012

(51) Int. Cl. G06Q 30/02

(52) U.S. Cl. 705/7.33; 705/7.29

(57) ABSTRACT

Systems and methods for providing display data indicative of trend data include providing, at a server, a set of queries for product content, wherein the product content comprises attributes of a product; receiving, at the server, a request to sort results from the set of queries based on the attribute and on a time period; generating a value based on the sorted query results and the time period; aggregating each value for each time period with values from other results from other queries within the time period; storing the aggregated value in a database; retrieving the stored value to determine trend data relating to the product content; and providing display data indicative of the trend data.

### BACKGROUND

The present disclosure relates generally to providing trend data and more particularly, to providing trend data of multiple values. Products such as automobiles, mortgages, certificates of deposits, bank accounts, etc. include product content, which may include interest rates, minimum deposits, annual percentage rates, etc. These attributes of the product content can be of interest to a user who wants to know more about the products and the trends associated with the attributes. Attributes may include, but are not limited to, user defined attributes (e.g., down payment of $15,575) or pre-defined attributes (e.g., down payment pre-defined as ten percent).

### SUMMARY

Implementations of the systems and methods of providing trend data are described herein. One implementation is a method that includes providing, at a server, a set of queries for product content. The product content may include attributes of a product. The method may also include receiving, at the server, a request to sort results from the set of queries based on one of the attributes for each of a plurality of time periods. The method may further include generating a value based on the sorted query results and one of the plurality of time periods. The method may also include aggregating each value for the one of the plurality of time periods with values from other results from other queries within the same one of the plurality of time periods. The method may also include storing the aggregated value in a database. The method may also include retrieving the stored value to determine trend data relating to the product content. The method may include providing display data indicative of the trend data.

Another implementation is a system including a server configured to provide a set of queries for product content. The product content may include attributes of a product. The server may be configured to receive a request to sort results from the set of queries based on one of the attributes for each of a plurality of time periods. The system may also be configured to generate a value based on the sorted query results and one of the plurality of time periods. The system may also be configured to aggregate each value for the one of the plurality of time periods with values from other results from other queries within the same one of the plurality of time periods. The system may yet further be configured to store the aggregated value in a database. The system may also be configured to retrieve the stored value to determine trend data relating to the product content. The system may be configured to provide display data indicative of the trend data.

Another implementation is a non-transitory machine-readable storage medium having recorded and stored thereon instructions that, when executed, performs actions including providing a set of queries for product content, wherein the product content may include attributes of a product. The medium may be configured to receive a request to sort results from the set of queries based on one of the attributes for each of a plurality of time periods. The medium may also be configured to generate a value based on the sorted query results and one of the plurality of time periods. The medium may be configured to aggregate each value for the one of the plurality of time periods with values from other results from other queries within the same one of the plurality of time periods. The medium may be configured to store the aggregated value in a database. The medium may also be configured to retrieve the stored value to determine trend data relating to the product content. The medium may be configured to provide display data indicative of the trend data.

The details of implementations of the disclosure are set forth in the accompanying drawings and the description below. Other features, aspects, and advantages of the disclosure will become apparent from the description, the drawings, and the claims.

### BRIEF DESCRIPTION OF THE DRAWINGS

FIG. 1 illustrates a system in accordance with a described implementation;

FIG. 2 illustrates a flowchart showing a process for aggregating data in accordance with

FIG. 3 illustrates a flow chart for retrieving data in accordance with a described implementation;

FIG. 4 is a flow diagram of a method in accordance with a described implementation;

FIG. 5 illustrates a system in accordance with a described implementation;

FIG. 6 is an illustrative screenshot of a website including product content;

FIGS. 7A-7C are illustrative screenshots of a website including mortgage data;

FIGS. 8A-8C are illustrative screenshots of a website including credit card data;

FIGS. 9A-9C are illustrative screenshots of a website including certificates of deposit data;

FIGS. 10A-10C are illustrative screenshots of a website including checking account data

FIGS. 11A-11C are illustrative screenshots of a website including savings accounts data; and

FIG. 12 is a block diagram of devices that may be used to implement the systems and methods in accordance with the described implementations.

### DETAILED DESCRIPTION

In a brief overview, raw data is collected about how product values change over time. A graph of how product values, e.g., APR (annual percentage rate), has changed over time, e.g., the last 6 months, is useful.

Historical results may be collected and displayed for pre-defined scenarios. For example, to provide the APR graph, various scenarios are periodically queried (e.g., 500 k mortgage, 30 year fixed, with good credit in Santa Clara county). The various scenarios may include a pre-defined set of scenarios that collectively represent most or all of the product space. Scenarios may be defined by listing pre-defined values for query attributes (e.g., subset of database schema). The set of possible scenarios may be the Cartesian product and may include property type (e.g., single family home, condo, etc.), loan amount (e.g., $100,000, $400,000, $600,000, etc.), credit score (e.g., 600, 640, 680, 720, 760, etc.), etc. Other scenarios may be queried. In some implementations, scenarios related to less popular values (e.g., investment property) may not be queried in order to minimize storage space in a database. Relevant parts of the scenarios may be saved as output.

Each scenario may have a key derived from the attribute values that uniquely identifies the scenario. The key may be used to store the historical values in the database. A scenario matcher matches a user query to the closest predefined scenario. A scenario retriever may obtain results from the database. When trend information for a specific input scenario is requested, then the trend information is matched to the pre-defined scenario. The results (output) may be retrieved by a scenario retriever, from the database, based on a matched scenario. The retrieved results/output may generate graph trend(s) of the product values.

Conventionally, trends for a single value may be graphed, e.g., trends for a single stock price. For multiple values changing over time, e.g., a set of search results/large data set, it is challenging and difficult to compute, track and provide trend data.

Implementations described herein relate to retrieving data as separate data series, with each separate data series being a series of single-valued data (e.g., the value of an attribute at a point in time). Each data point in an output series may be generated from a large set of input values. Simultaneously, a large number of series (e.g., several million) may be examined, each of which has a large amount of raw data per point in time. Tracking multi-valued data sets are described herein.

Multi-valued data sets may represent various product types, product content, and results related to product content. The products may be any types of products, such as the wide variety of products available for sale or for research on the Internet (e.g., electronic devices, handbags, and other products). In the example implementations, financial products are shown, e.g., mortgages, certificates of deposit, credit cards, etc. However, other product types and product results may be used, e.g., price changes for automobiles. Users may specify search criteria (e.g., define search attributes) for their situation (e.g., location, home value, credit rating, etc.) and the website compiles relevant trend data from a database of raw data and provides results for products that meet those criteria (e.g., matches the attributes).

Users may want to know rates at the time of their query. Users may also want to know previous rates for their search criteria in order to see trends in how rates are changing. For example, a user searching for/requesting information regarding mortgage data may also define a range for interest rates to be provided with the mortgage data search results. Additionally, the user may want previous interest rates from a time period, i.e., trend data. For example, a display of how APR has changed over the last six months may be useful to the user. Raw data may be generated to provide trend data.

In one embodiment, a first part involves gathering raw data. The goal of this part is to generate raw results for later processing. A second part involves aggregating the raw data, as a pre-computation. The goal of this part is to compute the data that will be served from the raw data in response to a user query. The third part involves serving trends queries. The goal of this step is to quickly retrieve values for display to the user. In an alternative embodiment, the second part may be omitted and instead the raw data may be retrieved and computations performed at the time of receiving a user query for a trend.

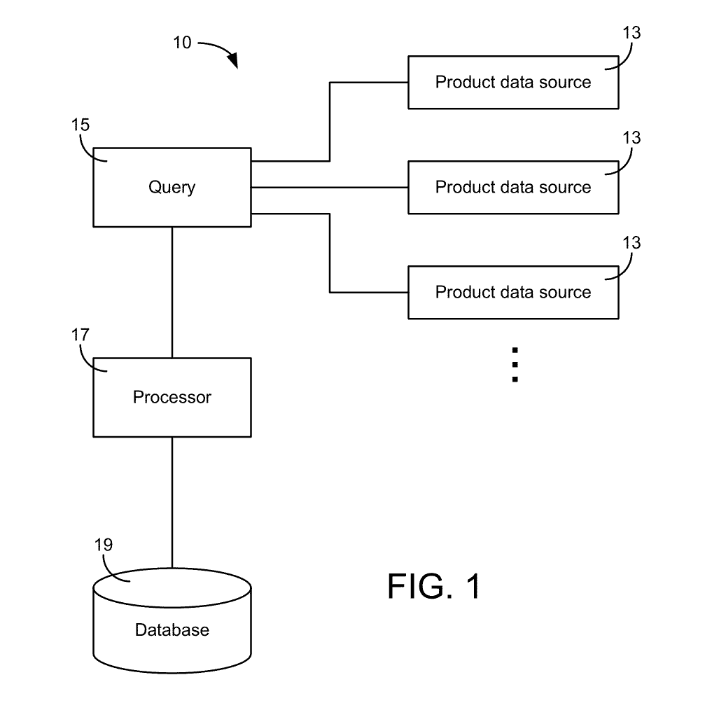

FIG. 1 illustrates an example system for generating raw input data in accordance with a described implementation. The generation of raw data may be used for subsequent steps of processing, aggregating and providing trend data. System 10 is provided by way of example, as there are a number of ways to carry out the generation and collection of raw data.

The system 10 generates a set of queries 15. The set of queries 15 are designed or configured to provide a representative view of the product space for a product of interest by crawling various product data sources 13. Product data sources 13 may include web pages, web sites, and other sources of product information.

A processor 17 may be used to continuously iterate over these queries and provide them to a website backend and/or database 19. Each query result with a timestamp may be logged to a disk and/or stored in a database 19 for later processing, e.g., aggregating the data or statistics.

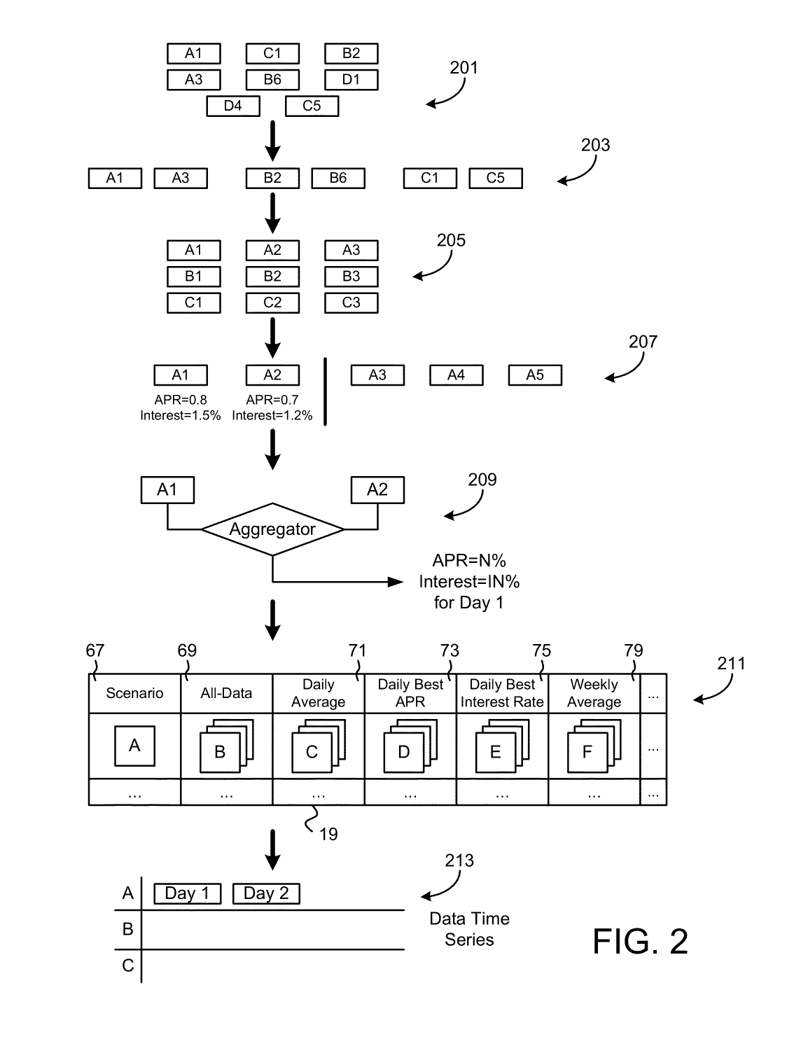

FIG. 2 is an illustration of a method of processing or aggregating raw data or statistical data and providing the processed data for use as trend data. FIG. 2 is provided by way of example, as there are a number of ways to carry out the aggregation of data. Unsorted, raw data at 201 are received in response to a query, such as the queries 15 in FIG. 1. In the illustration of FIG. 2, each data element comprises a letter indicating the query that resulted in the data element and a number indicating sequence. Each box 201 is representative of one set of search results, for the query at the time sequence. For example, query A may search for APRs (annual percentage rate)/interest rates of 30 year mortgages. This query may run once per day, so data element A1 and A2 indicate the results of each sequential query on day 1, while A3, A4 and A 5 represent the sequential results of the query on day 2, etc.

The unsorted, raw data at 201 is then sorted by query at 203, e.g., the raw data is subdivided by product query. The product query may then be sorted by sequence at 205, i.e., each product query is iterated over the raw results in chronological order. The sorting by product query and sequence may be performed by a framework for processing across large datasets using a large number of computers (e.g., a cluster, grid, hybrid, etc.)

For each product result, the raw numeric attributes of interest (e.g., for a mortgage, interest rate and APR) are accumulated with values from other product results within the same time period (e.g., within the same day.) The product results are separated by time period (e.g., the vertical line in FIG. 2 at 207 represents a time period boundary) and relevant values are extracted. For example, APR and interest rate for each set of values are extracted for each box at 207. A “product result” is all the properties and the set of attribute values for a single product at a particular point in time. A product is a single specific query result that a user might purchase from a specific advertiser. In one example, for mortgages, a “product result” may include everything pertaining to a loan offer being made by a specific lender for a specific set of query criteria, such as the properties and attribute values (e.g., fees, interest rates, terms and conditions, etc.) for the loan being offered by Bank A at 2 PM PST on Nov. 23, 2011, for a 30 year fixed $400 k loan to purchase a single family home worth $600 k to be used as a primary residence in Santa Clara County for someone with a good credit rating willing to pay up to 1 point and any other criteria.

For each query and time period, a set of values may be gathered. An arbitrary computation may be applied to the set to generate an aggregated value of interest (e.g., mean value, best value, etc.) per time period. An aggregator 209 may be used, e.g., each box in 207 may be input into the aggregator 209 to obtain a single value output. An input may be provided to the aggregator 209 one at a time. The aggregator 209 may apply a computation to the value to store its effect on the end result. Once the aggregator 209 receives a final input, a final computation is performed and an output value is provided.

The aggregator 209 may be a framework to combine all values for a specific query and time period into a single value. The aggregator 209 may incrementally accept a single value without having prior knowledge of what future inputs may be (i.e., the number of values and the properties of those values are unknown.) The aggregator 209 handles all of the details of separating the values, providing them as inputs, etc. Each type of computation may supply information as to how to perform the computation.

The framework handles the details of sorting and separating the time periods, and extracting only the values of interest. The framework then feeds these values one at a time into an “aggregator” or “accumulator” function (i.e., a unit of logic), which contains the logic needed for a specific computation type (e.g., mean, best, etc.). The accumulator's logic may be separate from the details of the framework and the logic for computing the mean or the best value may be specified in a simple manner. For example, adding a new accumulator type may be as simple as describing the logic for how to perform the computation on a set of numbers, without any regard to the complexity of the rest of the system. The framework may be easily extendible if other computation types are added.

In an example, the average value may be determined. The framework knows to feed each individual value into the aggregator 209, and when it encounters each value, the average aggregator increments a counter, and adds the input to a running total. At the end, when the aggregator 209 is asked for the final value, it divides the total by the counter. The average aggregator handles each input one at a time, performs the final computation, plugs these functions into the framework. The framework can crank any large amount of data through it to generate a graph.

In the example of FIG. 2, the data sets A1 and A2 are aggregated per time period, e.g., day 1 in FIG. 2. The data set A1 is received by the aggregator. The aggregator then applies a computation to A1 to store its effect on an end result. Similarly, the dataset A2 goes through the process. Other datasets A3, A4, and A5 may also go through the process. The datasets are then separated by time period and relevant values, APR and interest rate, are extracted. For example, A1 and A2 are grouped together by day one and A3, A4, and A5 are grouped together by day two.

In the case where A1 and A2 are query result sets (i.e., each contains a set of product results for a specific query for a specific point in time) from day 1, and A3-A5 are from day 2, then the framework may feed the APR for each product result in the query result sets A1 and A2 (A3-A5) to the mean accumulator, and then ask the accumulator to provide the final value for mean APR for day 1 (day 2 for A3-A5). Repeat both steps above for interest rates to get the mean interest rate values for days 1 & 2. The data is fed to the accumulator, which then provides a single value for each attribute for each day, and these values are then stored into the database. These steps are repeated for all statistic types that the system deems relevant (e.g., best, rolling average, etc.).

A number of methods may be used to aggregate the data. In some implementations, the logs may be aggregated (e.g., used when bootstrapping the system) to generate all data points. In some implementations, the values stored in the database may be aggregated. This may be done on a periodic basis for the most recent data points. For example, values may be recomputed every few hours for the last two days across the database.

In FIG. 2, at 211, an example of a database design is shown. Other designs may be implemented for storage and/or retrieval. The database 19 may have a number of columns and a number of rows. The columns may include scenario 67, all data 69, daily average 71, daily best APR 73, daily best interest rate 75, weekly average 79, weekly best APR, weekly best interest rate, monthly average, etc. The columns may also include many result sets.

As an example, block A is a row key. A row key is a human readable summary representation of the scenario (input query criteria). The key may be generated quickly based on a query, sorting the database quickly, and making retrieval fast. The row key of database 19 may be equivalent to a scenario (e.g., fingerprinted). Fingerprinting may be implemented within the system. Fingerprinting is a way of taking some data (the full scenario inputs) and generating a key from it, for example, by using a hash function. This may result in a potentially smaller row key that is not human readable. In some implementations, the entire scenario (or a subset of the entire scenario) may be used for the row key. For example, if the scenario data may be stored in the database 19, then a more elaborate row key may be implemented. In other implementations, an additional column may be implemented to store the scenario.

As an example, block B is a timestamped result set for a single query, i.e., the raw results of a query for the scenario at a single point in time. This cell may include many result sets with different timestamps. As an example, Block C is a timestamped aggregated result for average daily results. There may be a result per day for block C. As an example, Block C may include the output of the average aggregator 209 for that day and/or for all statistics that are being aggregated. As an example, Block D is a timestamped result for the daily best APR. There is one result per day for block D. Block D may include the search result for the product that had the best APR for the specified day. As an example, Block E is a timestamped result for the best interest rate. As an example, Block F is a timestamped aggregated result for average weekly results.

In FIG. 2, at 213, the summary values may be stored in the database 19 for retrieval. For example, for query A, day 1 includes relevant values that have been extracted from each query for day 1, while day 2 includes relevant values that have been extracted from each query for day 2. Each day following day 2 may culminate in a data time series. The data time series may be stored for A, B, C, and so forth throughout the database 19.

A, B, C, etc. refer to specific query scenarios, e.g., the input parameters for a user's mortgage. For each scenario, the output of the system is, for each day, a single numeric value for each of a set of output attributes (e.g., for mortgages the attributes are interest rate and APR). For example for mortgages, a scenario (i.e., a particular letter—A, B, C) may be “30 year fixed mortgage with loan amount 400 k for the purchase of a single family house worth 600 k in Santa Clara County, for a purchaser with good credit rating willing to pay up to 1 point”. For the above scenario, for a specific day, the output may be “For this specific scenario on Nov. 22, 2011, the average APR was X % and the average interest rate was Y %”. The database 19 may include one output entry for each day for which there is data. There may be another output entry for best values.

The data time series may be a collection of data across many days for a single scenario, e.g., “all the values for average APR for specific scenario A, one value per day”. The database may include these series for millions of different scenarios, and the letters represent the different scenarios (stored as rows in the database) and the days are the time points for the data series (stored as columns in the database). Other database configurations may be implemented.

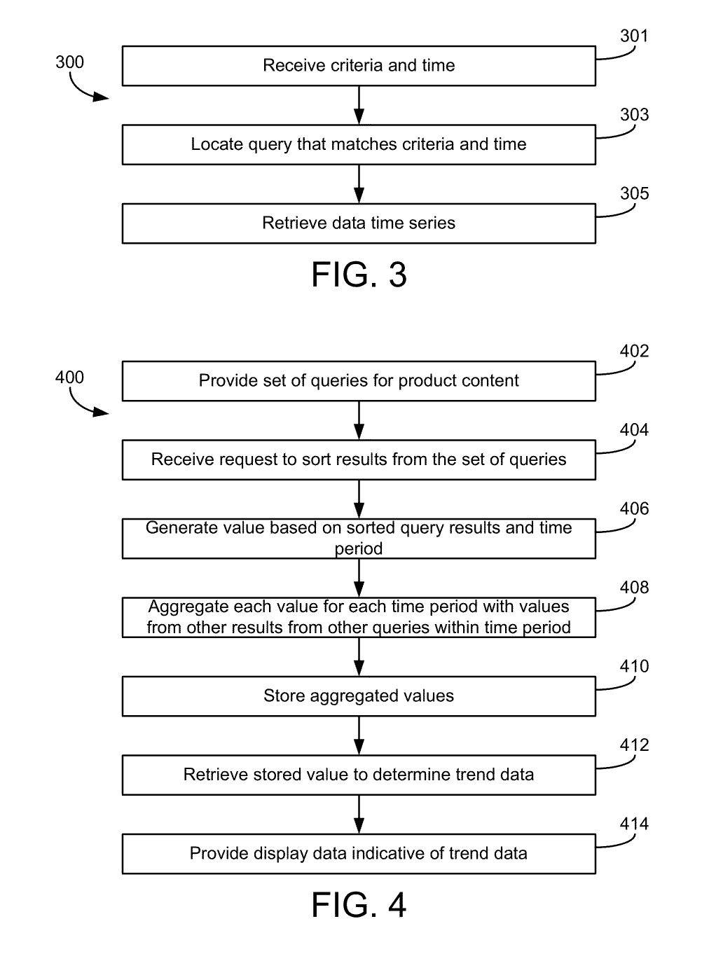

FIG. 3 is an example of providing trend queries. The trend queries may be quickly retrieved to provide trend data to the user. At block 301, query criteria and a time range may be received from a user via a web page. For example, a user may ask for trend data by specifying query criteria and a time range. At block 303, a query is located among the aggregated data that matches or closely matches the query criteria and time range. At block 305, the data time series (shown in FIG. 2 at 211) generated (i.e., located query) may be retrieved.

In some implementations, the computing of data that is provided from the raw data, i.e., aggregating the statistics, may be skipped as a pre-computation. For example, instead, the raw data may be retrieved and the computation may be performed at the time of query. This may provide similar results as aggregating the statistics as illustrated by FIG. 2. However, it may provide results in a slower fashion from a user's perspective.

The aggregation method illustrated in FIG. 2 may be implemented with a slight shift in the pipeline, meaning that the computation may be the same whether a pre-computation is performed and storing the aggregated values in a database (as described herein) or if the raw values are stored and computed as the trends query is requested. The difference between the two implementations is simply shifting when the computation happens, i.e, the computation is performed ahead of time or at the time of the query. The former incurs a cost to perform these operations ahead of time, but may provide a faster lookup at query time, whereas the latter may avoid the up-front cost, but is slower because it does the query at serving time.

In some implementations, the raw data may be aggregated as it is received. For example, at the time the query is performed, the average, best, etc. value of the result set may be immediately computed. The value may be stored, which may reduce the input data to a single value immediately. This may reduce the method to a single value, e.g., stock charts. The output may be similar to the output generated by the aggregation method as illustrated in FIG. 2.

In some implementations, the aggregation method, as illustrated in FIG. 2, allows changes to future aggregation of data. In some implementations, the aggregation method provides accurate data even when the data set that contributes to a single output value is gathered by multiple queries. The aggregation method may be part of a method for providing display data indicative of trend data.

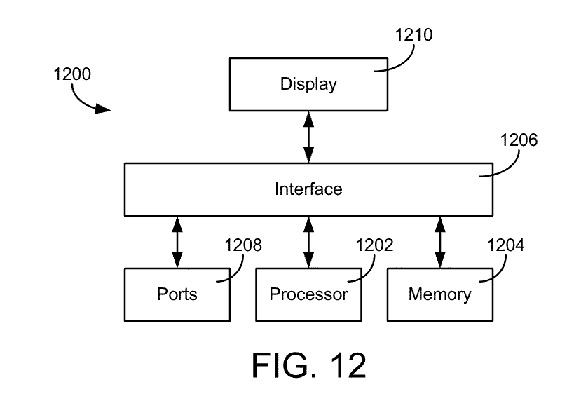

FIG. 4 is a flow diagram of a method for providing display data indicative of trend data in accordance with a described implementation. The method 400 is provided by way of example, as there are a number of ways to carry out the methods according to the present disclosure. The method 400 shown in FIG. 4 may be executed or otherwise performed by one of a combination of various systems. The method 400 may be implemented by a computer, a computer program product, a computer program, a client, a server, a client-server relationship, etc. The method 400 is described herein as carried out by the system 1200 of FIG. 12, by way of example.

Example method 400 begins at block 402, in which a set of queries for product content is provided. In some implementations, queries may be periodically provided by the server (e.g., the search system), user, etc. In some implementations, queries may be generated by the system to provide a representative view of the product content. The system may be further configured to iterate over these queries and issue them to a database. For example, each query along with a timestamp may be logged and stored in the database.

In some implementations, the product content includes attributes of a product. Product content may include information about mortgages, credit cards, certificates of deposit, checking accounts, savings accounts, other financial instruments (e.g., savings bonds, etc.). Attributes may include qualitative values (e.g., names, locations, phrases, etc.). Attributes may include quantitative values. Attributes may include product provider information (e.g., lenders name, lenders website, etc.). For example, a $500,000 mortgage, 30-year fixed loan type, good credit rating, Vilas County, may be a set of queries for product content having attributes (e.g., the system includes a set of pre-defined attributes) or user-defined attributes (e.g., various search terms entered by users). Pre-defined attributes may collectively represent most or all of the product space.

At block 404, a request to sort results from the set of queries based on one of the attributes for each of a plurality of time periods is received. The queries may be subdivided by each query related to each product and product content. For each query related to product content, the system is configured to iterate over the raw queries in chronological order. The plurality of time periods may not require several time periods. For example, there may be a single time period, e.g., there is data for one month. For each product result, the system is configured to determine what attributes are important (e.g., for mortgages, the attributes of interest rate and APR may be selected as important) and generate a value representing the relevant attributes based on the sorted results from the set of queries and one of the plurality of time periods.

At block 406, in which a value is generated based on the sorted query and one of the plurality of time periods. In some implementations, the value generated is based on a statistical type, e.g., mean, median, mode, etc. In some implementations, the value generated is based on system definitions, such as best value.

At block 408, in which each value is aggregated for the one of the plurality of time periods with values from other results from other queries within the same one of the plurality of time periods. For example, each value may be accumulated with values from other product content within the same time period (e.g., within the same day.) For each query and time period, a set of values has been generated and aggregated. In some implementations, aggregating each value includes retrieving log data. In other implementations, aggregating each value includes retrieving queries from the database. In some implementations, different aggregation time intervals may be set (e.g., daily, weekly, monthly, etc.).

In some implementations, aggregating each generated value may include receiving each generated value to update a counter and adding each generated value to a total. Aggregating each generated value may also include receiving a final generated value and dividing the total by the counter.

At block 410, in which the aggregated values are stored in the database as a single value. In some implementations, the database is keyed on a human-readable summary At block 412, in which the stored (single) value is retrieved to determine trend data relating to the product content. In some implementations, user asks for trend data by specifying attributes and a time range. The stored value may then be retrieved by generating a key from the attributes and time range that matches the stored value.

At block 414, in which display data indicative of the trend data is provided. The trend data may include ranking the trend data. The ranking of trend data may be performed in real time, e.g., by performing the ranking after the request is received from the user for trend data. This may be provided in real time by aggregating the values at the time of the user's search. For example, the query may be received, the value of the query (e.g., result set) may be determined and stored as a single value, and the single value may be retrieved to provide display data indicative of trend data. For example, a user may request a specific query criteria (and/or time period), the stored single value may be matched to the user's query criteria, and display data indicative of trend data is provided to the user.

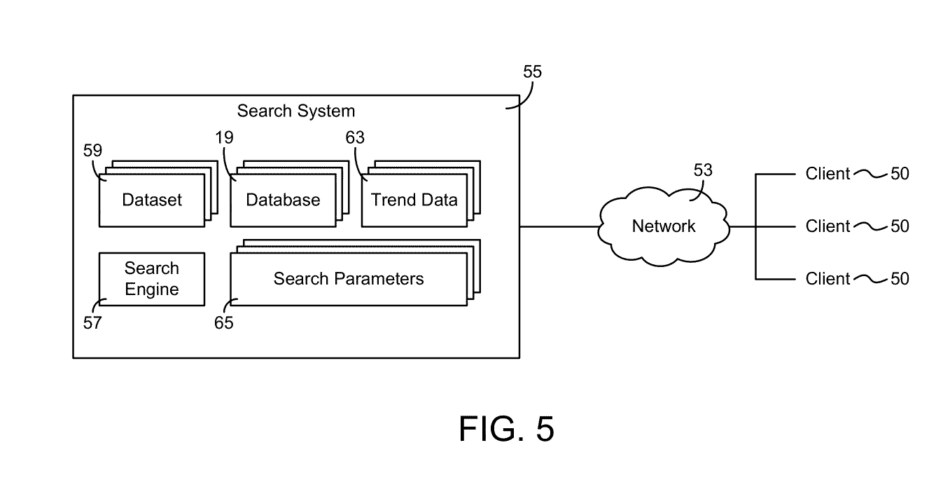

FIG. 5 is an illustration of an example of search system 55. Search system 55 may be in communication with system 10. Search system 55 may also be in communication with a user 50 through network 53. User 50 may be a human user, entity (e.g., company), or a non-human user, such as a computer program. Search system 55 may include search engine 57, datasets 59, database 19, search attributes 65, and trend data 63, the trend data 63 representative of multi-valued datasets 59.

Each dataset 59 may correspond to database 19. Search system 55 may associate multi-valued datasets 59 (e.g., results) or search attributes 65 with a user 50. User 50 may establish a user profile with search system 55 to define the user's preferences with regard to the attributes 65.

Search attributes 65 may include attributes of product content. Attributes may be provided by user 50, or provided by another source, e.g., a pre-defined set of attributes that represent most or all of the attributes of the products searchable within search system 55. Search system 55 may periodically run searches/queries using the pre-defined set of attributes and determine whether to store a particular attribute of the pre-defined attributes as a value within database 19. Search system 55 may receive searches using a set of attributes defined by the user and determining whether to store a particular attribute of the user-defined attributes as a value within database 19. Trend data 63 may be provided to user 50 by matching a user-defined attribute with a stored value by using systems and methods described herein.

The database 19 may be implemented to store raw data and values for later use in generating trends. The output data may continue to be logged, and the following database design may be a subset of that data organized specifically for ease of reading for trends. A recent subset of the raw data are stored in the database and logged, in order to ensure quick, periodic refreshing of the most recent results. The computed data is stored in a retrievable format for retrieval and providing of trend data. Database 19 may include a row key, cell contents, an “all data” column, other columns, multiple rows, etc.

In some implementations, there is a way (e.g., per vertical) to take a scenario and return a string. A vertical may be one product type, e.g., new home loans, refinance, savings account, checking accounts, CDs, are example verticals. This may be in the form of delimited attribute values (e.g., omit the attribute names if all scenarios provide values for all attributes). For example, “1/CA/Santa Clara/500 k/30 year fixed/ . . . ”, where the first attribute is the vertical ID.) “1/CA/Santa Clara/ . . . ” is an example of how you might take a scenario and return a string for use as a row key. Each element of the key (CA, Santa Clara, 500 k, etc.) is an attribute value that was used as search criteria. This example is for mortgages, where criteria such as state, county, loan amount, etc. are part of the search criteria. Attributes may be ordered in a way to form various prefixes that may be useful for broader trends. For example, it may be useful to look at all mortgages for a specific state, or by county, etc. The order of the attributes may make it possible to form these prefixes.

The database 19 may include cell contents. Each cell may hold one or more attributes. Each cell may include a protocol buffer of type ScenarioResultSnapshot. ScenarioResultSnapshot may include a set of attributes and the attribute values used to construct trends graphs. In some implementations, only a single attribute value may be needed. In other implementations, the single attribute value may be stored as a repeated field. Inserting a scenario result into the database may include distilling the scenario into the attributes that may be stored for later retrieval. The attributes needed to be stored may be defined per vertical.

The database 19 may include an “all data” column. Whenever a scenario result becomes available, each product in that result may be inserted into the “all data” column at its true timestamp and with a column suffix of the product key. In some implementations, the “all data” column may be the only column that uses suffixes. The “all data” column's GC (garbage collection) limit may be at least as long as the largest time range for one of the other columns. The “all data” column may be the only column written to when a scenario result is computed. The database may be configured to periodically delete data that is old and no longer needed. The GC limit defines what “old” means (i.e., cells in the database that are newer than the limit must not be deleted). The GC limit needs to be set high enough to avoid deleting data that may be needed. For example, if we wanted to compute averages across an entire month, then we need to retain “all data” for at least 1 month so that we can compute an accurate average for the entire month. If the GC limit was less than 1 month then, at any given time, there will not be enough data needed for a 1 month average.

The database 19 may include other columns. Other columns may include data aggregated from multiple timestamps of the “all data” column over some time period (i.e., each cell in other columns may be computed from a set of cells in the All Data column.) The time period and the method of aggregation may differ for each column (and some verticals may only use some of those columns). These columns may be populated by a periodic process which reads the all data column and, for each other column, computes the correct value to insert into the column at some nominal timestamp (e.g. a daily column may use the values from the past 24 hours and insert the result at a noon timestamp for that day). This means that adding a new column, for example, is adding a new function for computing this aggregation (on top of adding the column to the database schema). This aggregation may be added to the existing GC mechanisms in an overall system.

In some implementations, there may be multiple rows per scenario. If a row size gets too large, because there are a lot of columns, then it is possible to make multiple rows per scenario and have each row hold a distinct subset of columns for that scenario. The columns may need to be split into disjoint subsets where no single query reads columns for multiple sets.

In some implementations, other columns may be needed. Each column (aside from “all data”) may aggregate data along several lines (e.g., stat type, time period, etc.) For stat type, there may be average, best, all products, etc. For average and best column families, columns may be defined by attribute (e.g., APR.) For all products column family, columns may be defined by products. The all products column may be useful to track trends for an advertiser.

The “average” column may store the average value for all products for the scenario. The “best” column may store the product with the best value for a specific stat for the scenario. For example, for APR for mortgage data, the “best” value is the lowest APR, while the interest rate for checking account data, the “best” value is the highest interest rate. For the “best” column, there is a sub column (e.g. best:apr and best:interest_rate) for each important attribute. The per-attribute columns may be needed if the “best” or the “average” differs for different attributes, which may be true for some verticals. A per attribute column would be a column that stored best data for a specific attribute. For example, the product with the best APR might be different from the product with the best interest rate, so having a column that stored just “best” would be ambiguous. Each cell may hold one or more attributes. A component for determining average, best, etc. may be configurable per vertical and per attribute (e.g., some attributes may optimize for max value, some for min value.) The component may refer to the aggregator logic—how to configure an aggregator (for example, to determine best value) can differ depending on which vertical and which attribute you're interested in. For example, best interest rate for mortgages is the lowest, but the best interest rate for savings accounts is the highest. On the other hand, there may be some other attribute for mortgages for which best is highest rather than lowest.

The output data may be scoped so that there are different aggregation time intervals (e.g. daily, weekly, monthly). “Scoping” may refer to the fact that, depending on the size of the output range, the output may be returned at a different level of time intervals. For example, if the request is for a month's worth of trends data, then the results would be returned at the daily level, but for a year's worth of data, one data point per week may be returned.

For the time period, a single snapshot may be stored, e.g., daily, weekly, monthly, all, etc. This column may include one entry per time period. For example, daily_average stores the average values for all products for a day, and weekly_best:apr stores the product result with the best (lowest) apr for the entire week. The weekly and monthly columns may reduce data size of the daily column and reduce data volume when retrieving history over a large period of time. For the time categories: one entry per time period may be stored (e.g. “Daily” may have one cell per day and “All” may store all results.)

The database design may be able to serve results data by reading from a single row and column for any given query, and having the data stored in the database being more or less the final form needed. The columns described herein are the ones used to store the aggregated data, and aren't new columns from what's been described so far. For example, for a specific scenario, the daily_average column will have one entry per day containing the average values for the attributes for that day, weekly_average has one entry per week containing the average values for the attributes for that week, etc. When a query is received, the column needed is scoped (as described above), and then data is returned from the appropriate column without reading other columns.

In some implementations, a scenario may be added to all time categories. For “all”, the scenario may be added to its true timestamp. For daily, weekly, monthly, the scenario may be added to a nominal timestamp for each time period, e.g. daily may include all timestamps at noon of that day, weekly at noon of Wednesday, monthly at noon of the 15th. When the scenario output is written to the all data column, it may also be written to the daily/weekly/monthly columns at the nominal timestamp for the appropriate time period. Current timestamp to nominal timestamp for each time category may be configurable and mapped. Different verticals may be configured differently.

The last result in a time period may end up being the final value for that time period. For example, this may mean that for some weeks, the value for that week may be from Wednesday, and the next week it might be from Friday. If scenarios are run at a high enough frequency this effect may be less pronounced. In some implementations, at the end of each time period, the next column (e.g. daily looks at all, weekly looks at daily, monthly looks at weekly) may be read for all values in the period and selects one that is the best match to use for that time interval.

In some implementations, the database 19 may determine how much data for each time category, and set the GC rules to erase old data. For example, data related to all may be retained for 3 months, data related to daily may be retained 12 months, data related to weekly may be retained for 3 years, and data related to monthly may be retained for 10 years.

In some implementations, a graph may be constructed. A time category may be selected, which is most appropriate for the graph scale that is desired. The correct column may be selected for the attribute that is desired. For example, a graph for the best APR for the last 6 months is desired. The weekly-best column for the scenario desired is read and used to graph the data. In some instances, monthly column may have too few data points and daily column may have too many data points.

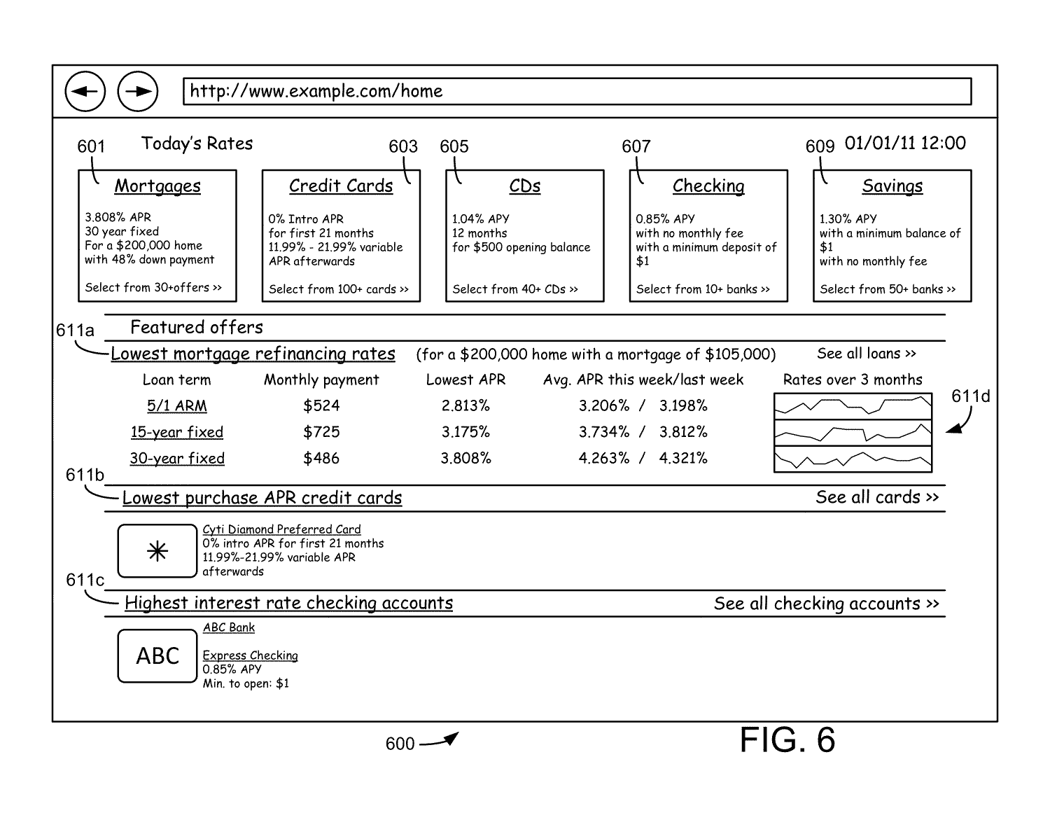

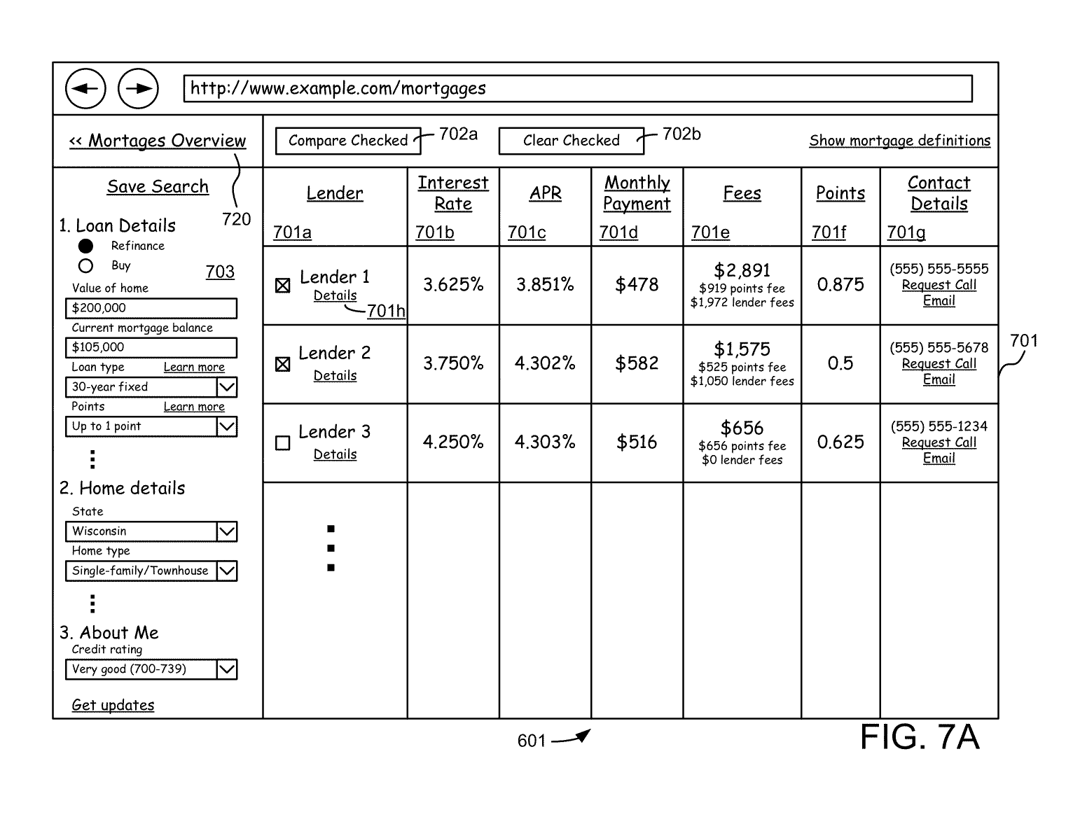

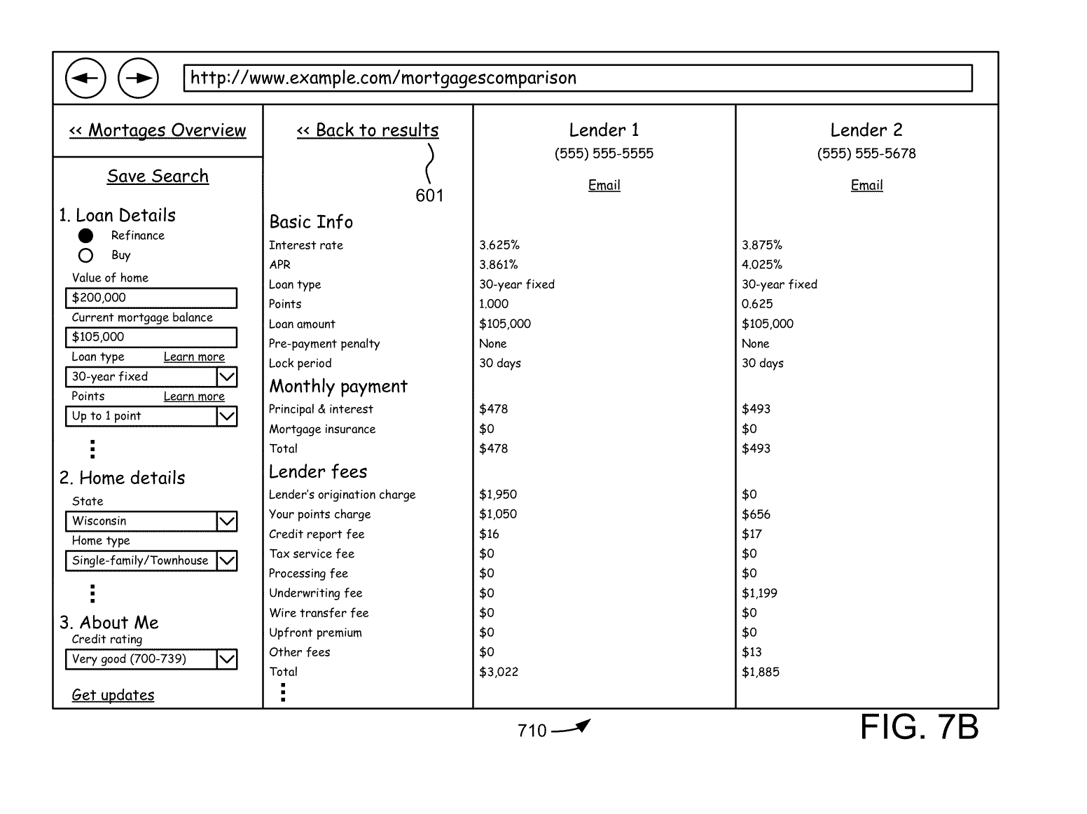

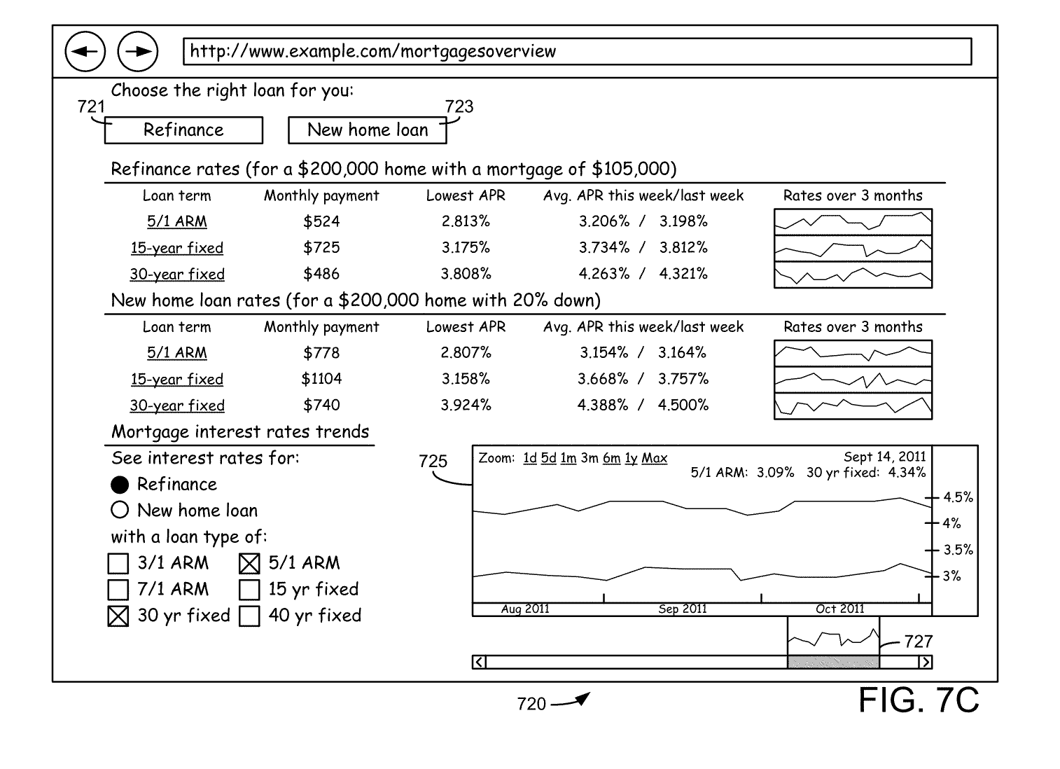

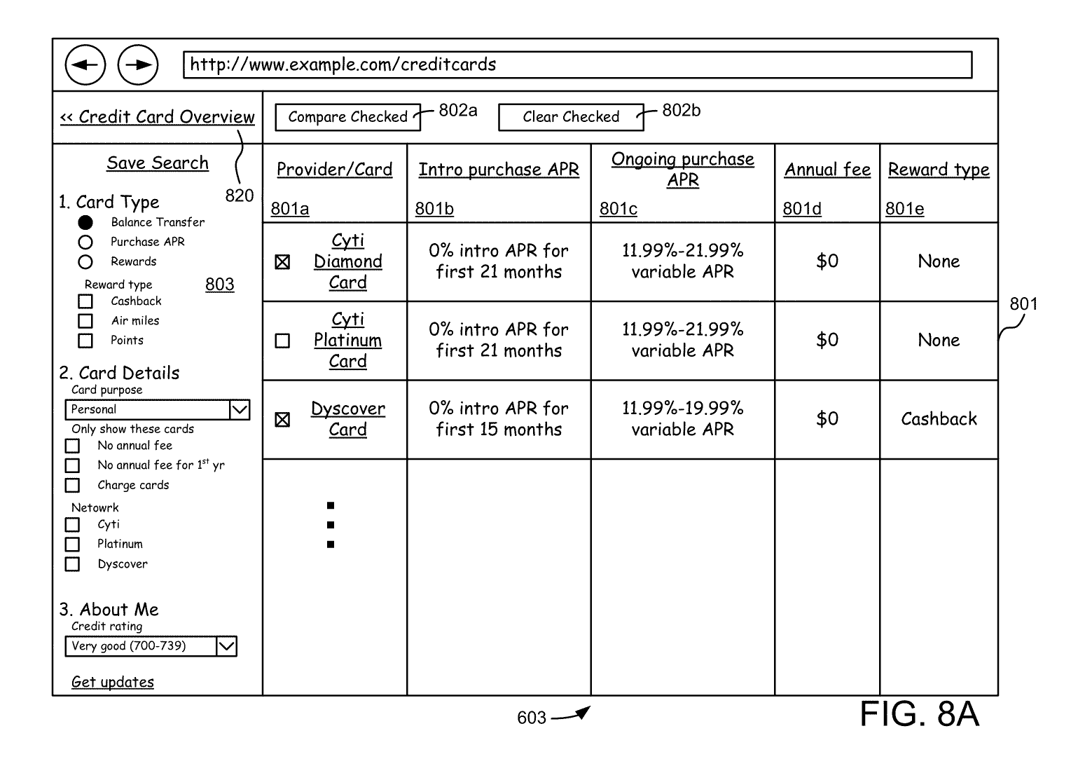

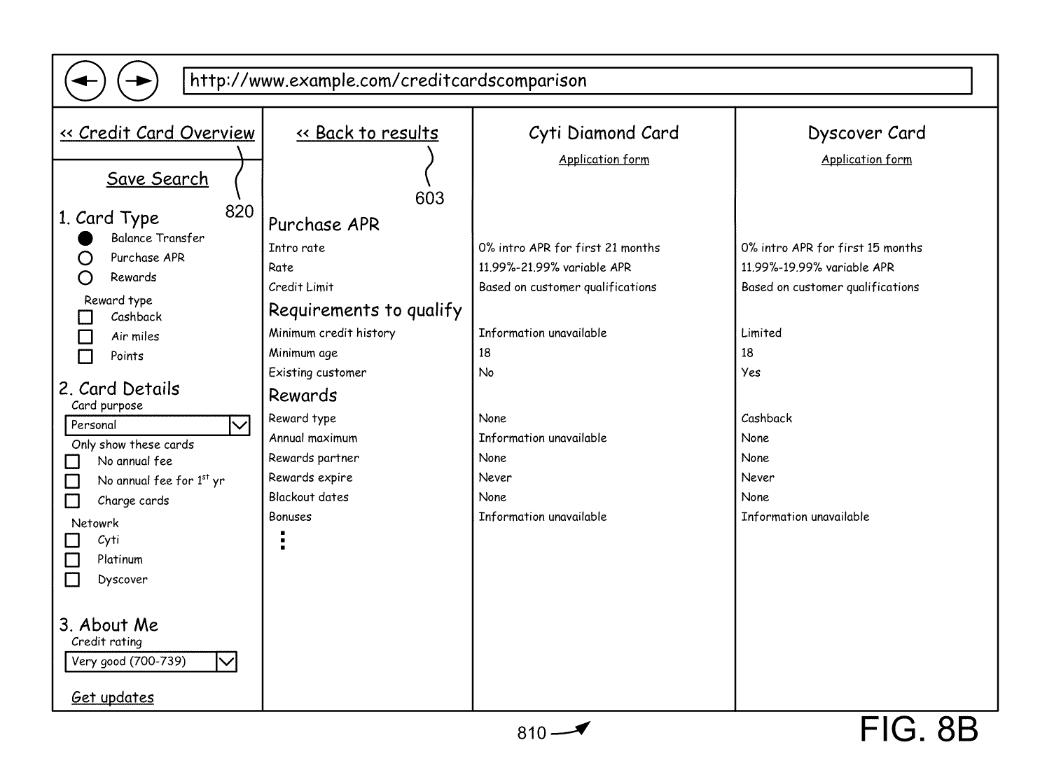

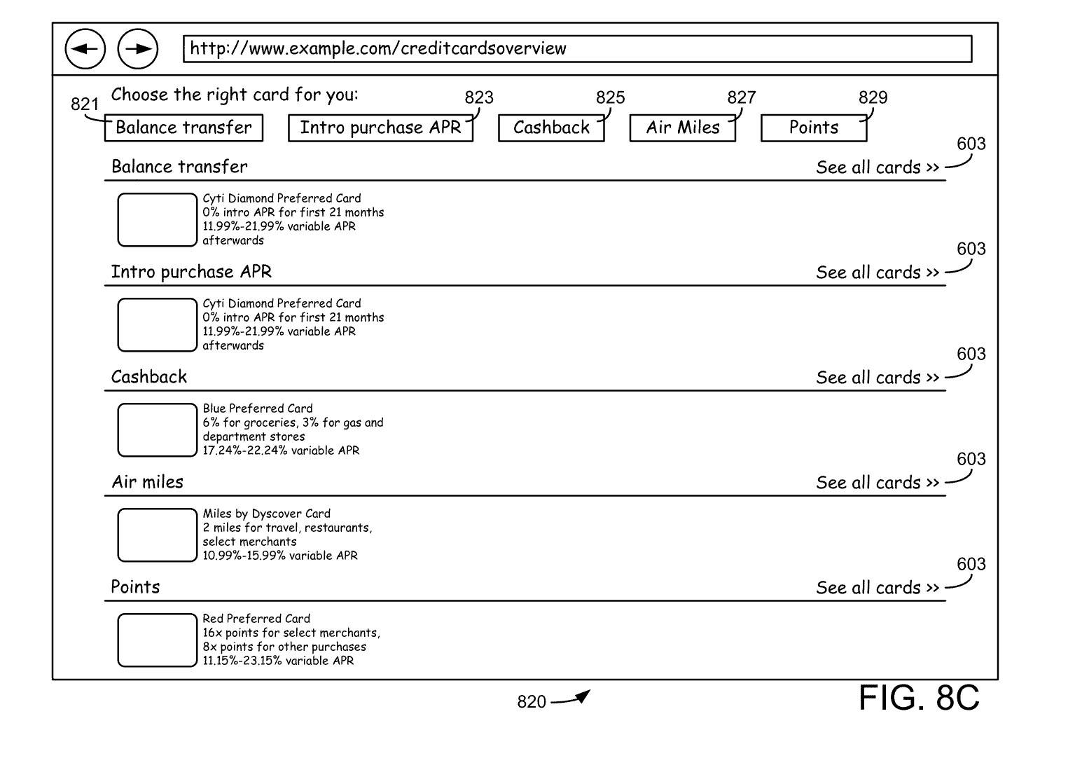

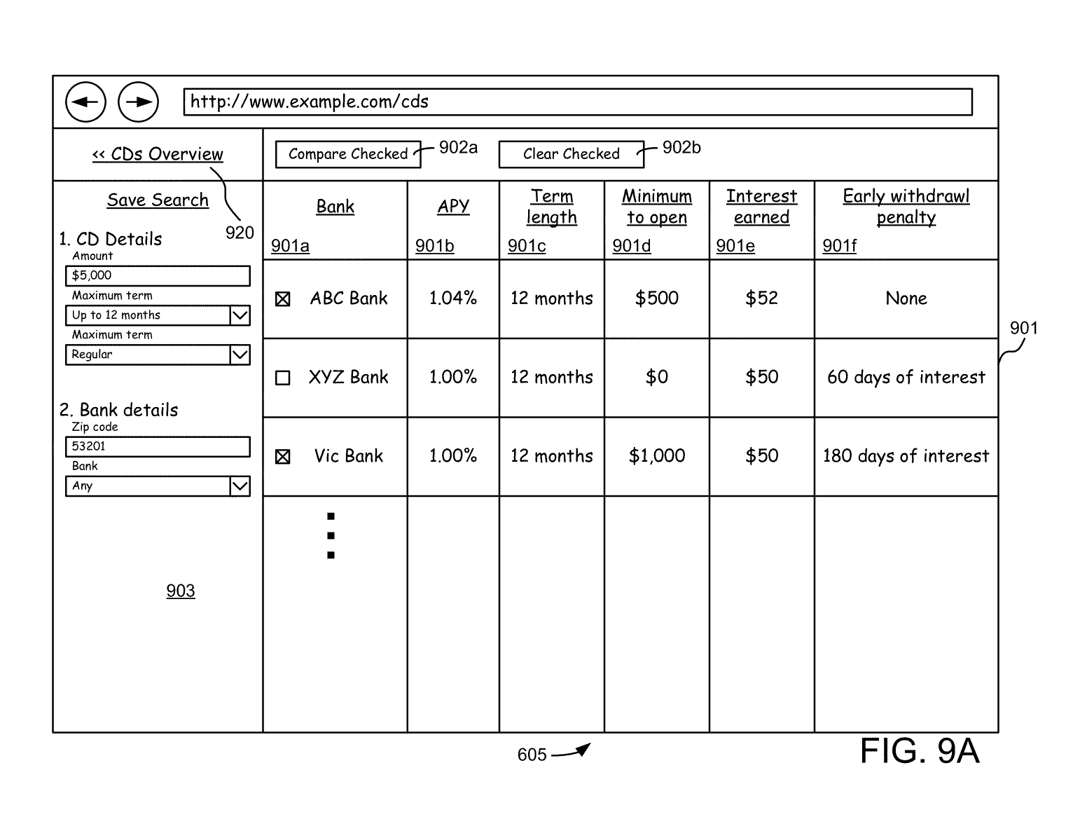

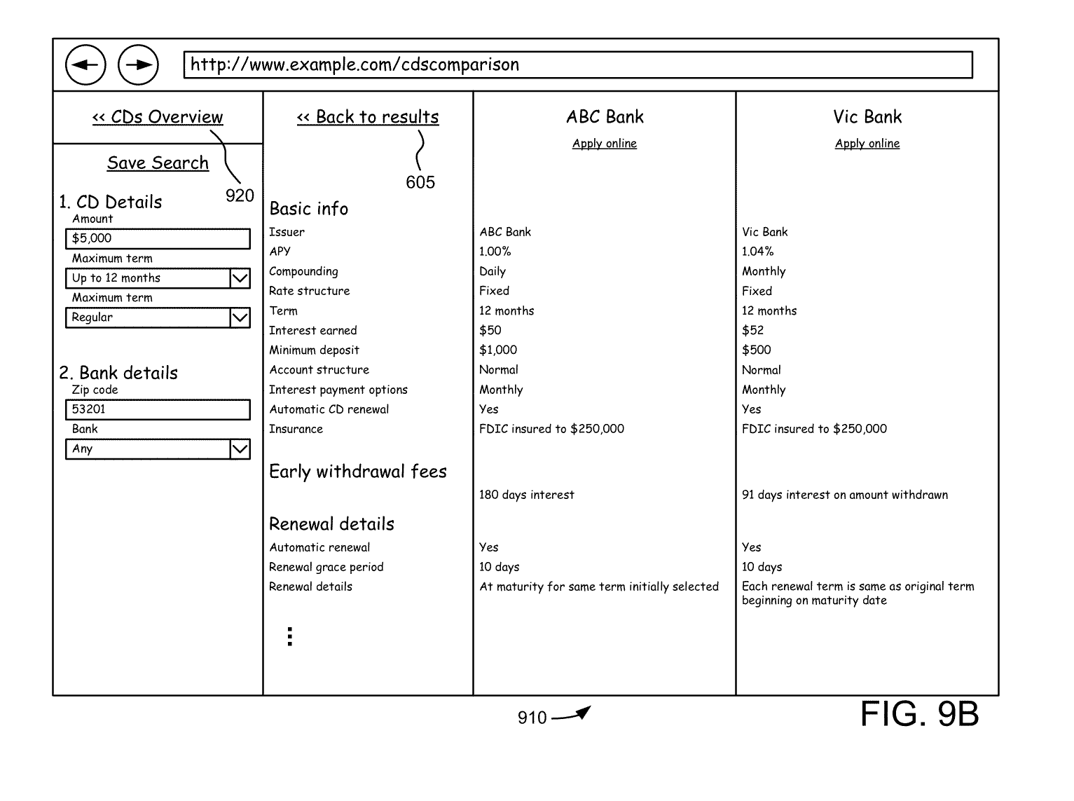

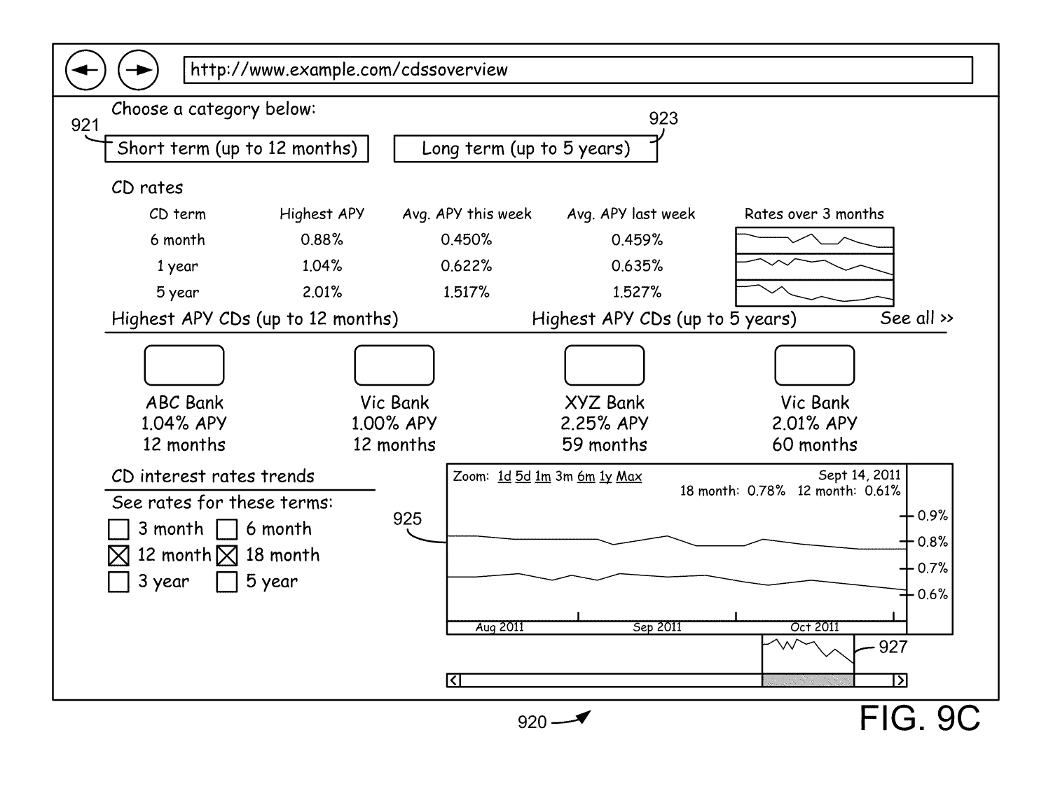

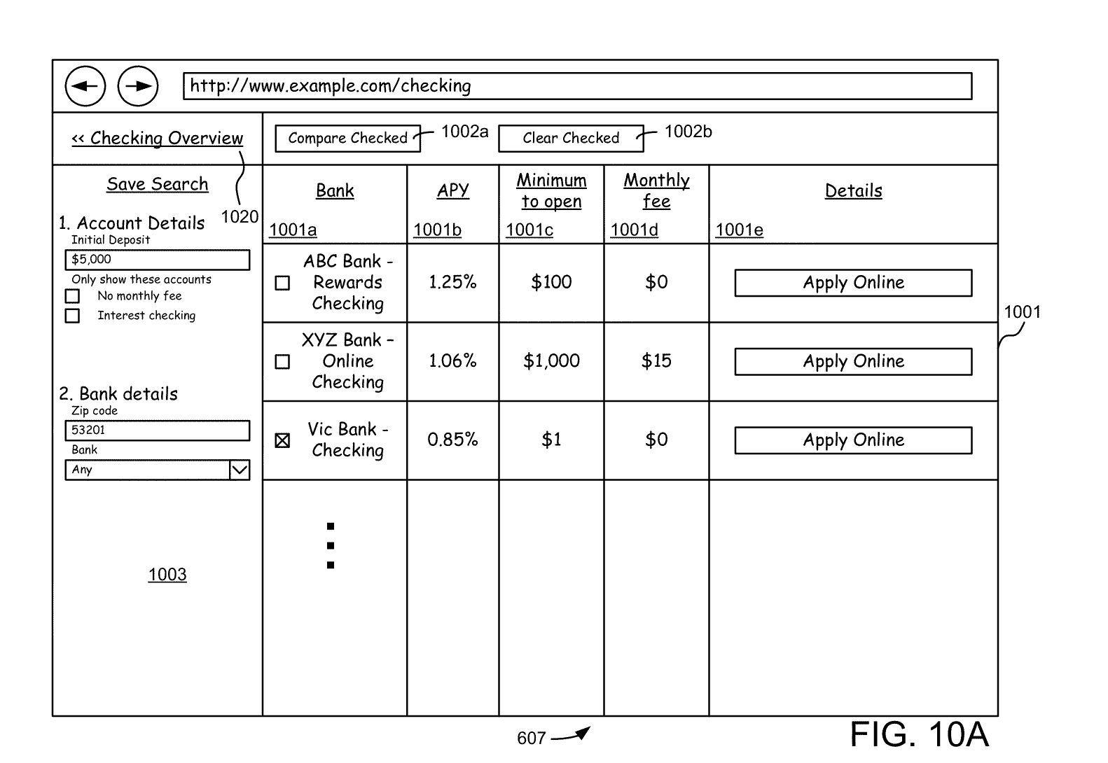

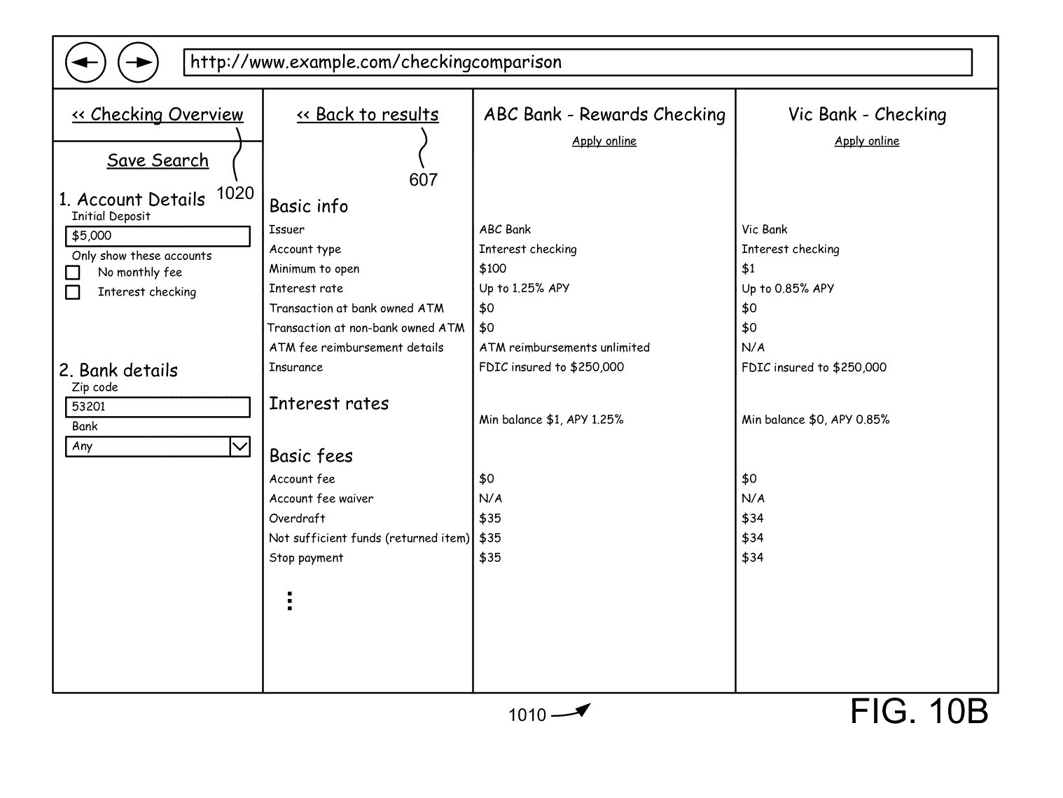

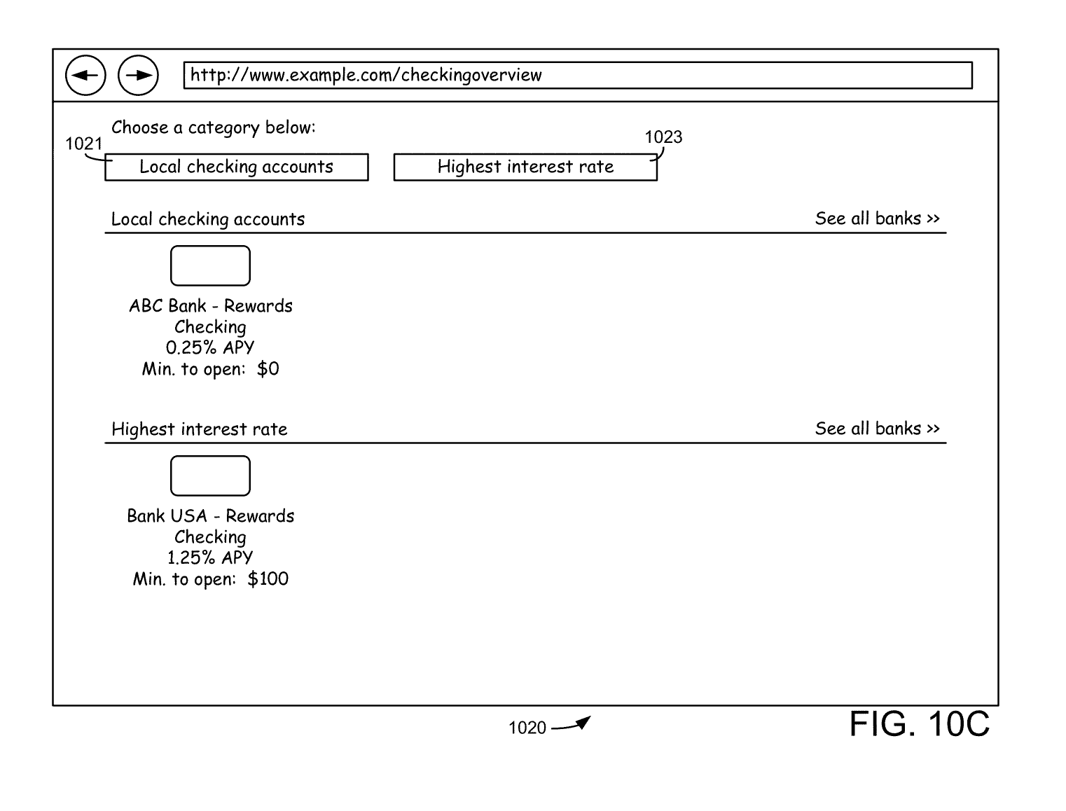

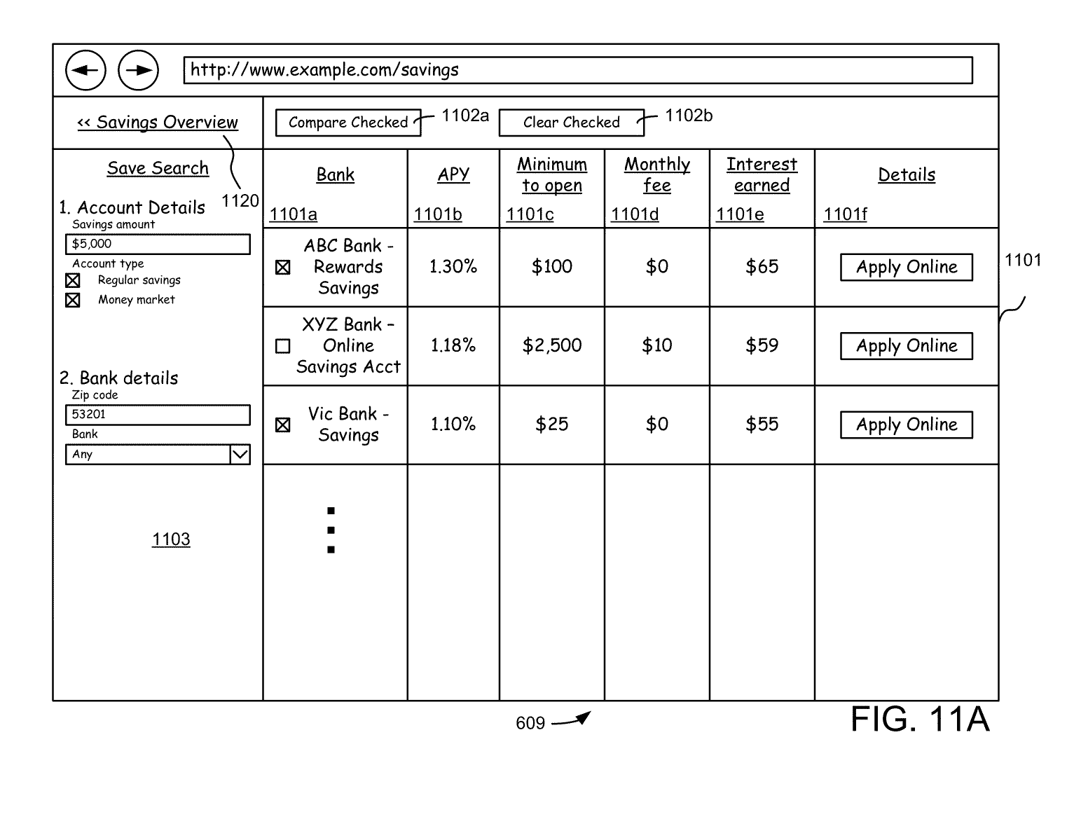

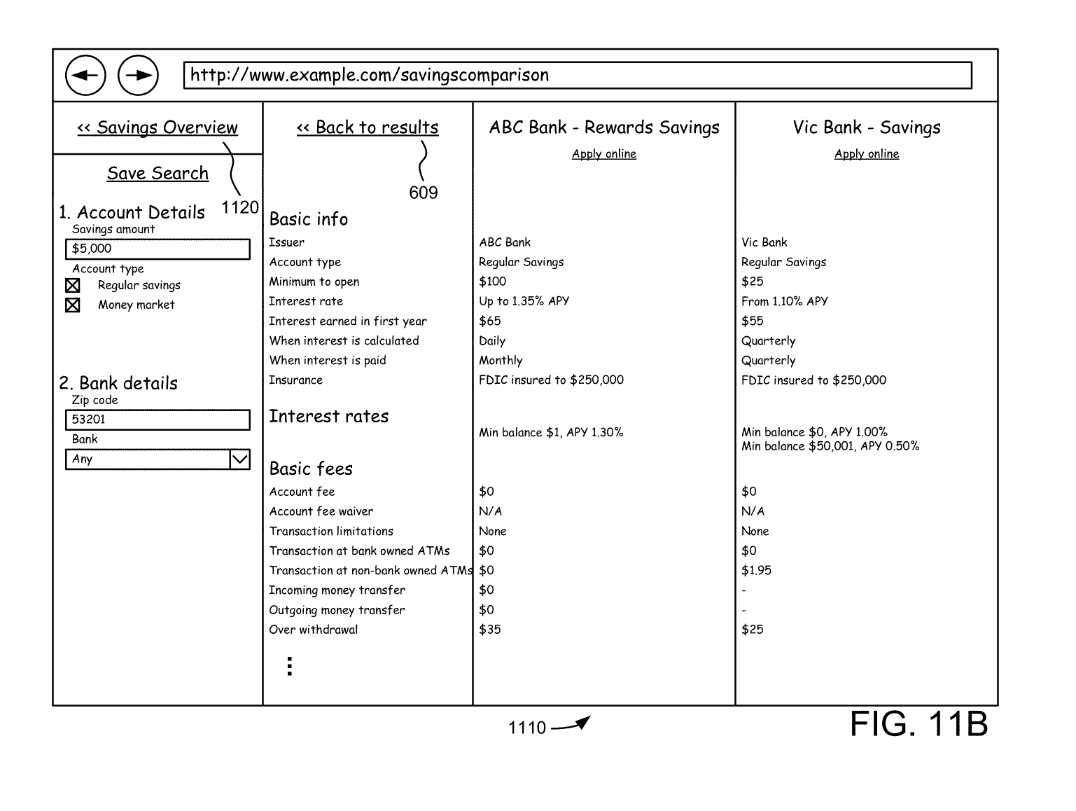

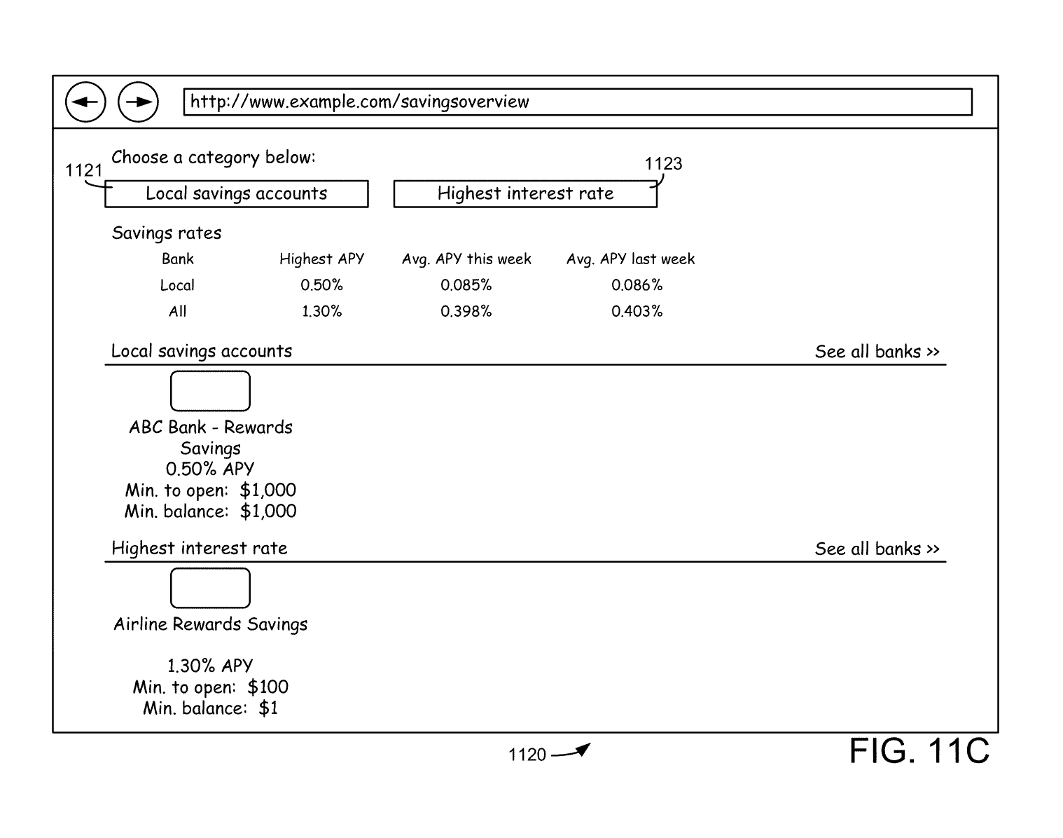

FIGS. 6, 7A-11C are illustrative screen shots of a user interface produced by an implementation of the aggregation method and system capable of displaying trend data. FIG. 6 is an illustrative screenshot of a website including product content, e.g., financial instruments. FIGS. 7A-7C are illustrative screenshots of a website including mortgage data. FIGS. 8A-8C are illustrative screenshots of a website including credit card data. FIGS. 9A-9C are illustrative screenshots of a website including certificates of deposit data. FIGS. 10A-10C are illustrative screenshots of a website including checking account data. FIGS. 11A-11C are illustrative screenshots of a website including savings account data.

FIG. 6 illustrates an example user interface in accordance with a described implementation. User interface 600 provides various product content related to mortgages 601, credit cards 603, certificates of deposit (CDs) 605, checking accounts 607, savings accounts 609, etc. In some implementations, user interface 600 displays additional product content. User interface 600 may be customized and/or personalized by a user.

User interface 600 displays product content from multiple providers, comparisons between the product content, online applications for product content, etc. User interface 600 includes current rates, (e.g., real time updates) such as annual percentage yield (APY), APR, etc., for the product content.

User interface 600 may display product content 611a-d, as shown in FIG. 6. For example, in FIG. 6, user interface 600 displays lowest mortgage refinancing rates 611a, lowest purchase APR credit cards 611b, and highest interest rate checking accounts 611c. The lowest mortgage refinancing rates 611a, lowest purchase APR credit cards 611b, highest interest rate checking accounts 611c may be determined from a previous search by user, previous searches by other users (e.g., for lowest refinancing rates 611a, the system provides results based on typical user search attributes: $200,000 house with a mortgage of $105,000 as shown in FIG. 6), previous searches by the system, etc.

Lowest mortgage refinancing rates 611a may include additional attributes. In FIG. 6, additional attributes may include loan term, monthly payment, lowest APR, average APR this week, average APR last week, and rates over three months 611d. As shown in FIG. 6, rates over three months 611d are displayed as trend data. In some implementations, trend data may be displayed as a stock chart (e.g., a combination of a line chart and a bar chart). In other implementations, the trend data may be displayed as a pie chart.

FIG. 7A illustrates an example user interface 601 in accordance with a described implementation. User interface 601 provides product content, which may include attributes of mortgages. In some implementations, user interface 601 displays other product content. For example, user interface 601 may include product content related to real estate searches. User interface 601 may be customized and/or personalized by a user.

In FIG. 7A, user interface 601 is an example of a display showing mortgage data and related attributes. User interface 601 provides display 701 to the user. Display 701 may be based on previous searches by a user, previous searches by other users, previous searches by a system, etc.

As shown in FIG. 7A, display 701 includes an organization of lenders 701a along with related attributes for each lender. The related attributes include interest rate 701b, APR 701c, monthly payment 701d, fees 701e, points 701f, and contact details 701g. Display 701 may be sorted by any of attributes 701a-701g. For example, display 701 may be sorted from highest to lowest APR, lowest points to highest points, etc. Each parameter may include a hyperlink. The hyperlink may include additional information (e.g., definitions, reference material, other websites, etc.), an action (e.g., contact a lenders), etc.

In FIG. 7A, lender 1, lender 2, and lender 3 are displayed as an example. Lender 1 includes details 701h. Details 701h may include lender and/or loan details. Details 701h may include lender details, e.g. lender 1's name, address, website address, telephone number, information regarding the lender, an online application, etc.

In some implementations, details 701h include basic information regarding the loan (e.g., interest rate, APR, loan type, points, loan amount, pre-payment penalty, lock period, etc.), monthly payment information (e.g., principal, interest, mortgage interest, monthly escrow deposits, homeowner's insurance, etc.), lender fees (e.g., origination charge, points charge, credit report fee, tax service fee, processing fee, underwriting fee, wire transfer fee, upfront premium, other fees, etc.), other closing costs (e.g., appraisal fee, property taxes, escrow, interest, insurance, etc.), etc. In some implementations, details 701h includes a fill-in form to contact the lenders from the website.

As shown in FIG. 7A, display 701 may be based on a current search 703 by user. The user may change display 701 via an interface configured to receive attributes for search 703. In some implementations, the user may enter loan details. For example, in FIG. 7A, the user may select refinance or buy a home. The user may enter the value of the home, the price of the home, down payment, current mortgage balance, 2^{nd} mortgage balance, additional cash to borrow, etc.

System may be configured to receive loan type (e.g., 10-year fixed, 15-year fixed, 25-year fixed, 30-year fixed, 40-year fixed, 3/1 ARM, 5/1 ARM, 7/1 ARM, 10/1 ARM, FHA (Federal Housing Administration, VA (Veterans Affairs), etc.) from user and/or provide additional information about each loan type, as shown by the “learn more” indication in FIG. 8A. User may enter information with regard to points (e.g., 0, 0.25, 0.5, 0.75, 1, 1.5, 2, 2.5, 3, 3.5, 4, etc) and/or obtain additional information about points, as shown by the “learn more” indication in FIG. 8A.

System may be configured to receive other details related to mortgages, e.g., homes. In some implementations, user enters details regarding new construction, rentals, recently sold, not for sale, etc. For example, as shown in FIG. 7A, the user may select the location of the home (e.g., within a specified distance of a zip code, street, city, neighborhood, etc., state, county, country, etc.). The user may also select the type of home (e.g., single family home, condo, townhome, row home, co-op, manufactured home, mobile home, farm, ranch, multi-family home, etc.). The user may also select what the home will be used for, e.g., (primary residence, secondary residence, investment property, etc.).

The system may be configured to receive a credit rating from the user (e.g., excellent, very good, good, fair, poor, etc). The credit rating may include ranges associated with each rating. These ranges may be adjusted based on current standards for credit ratings. Alternatively, the user may enter credit rating by entering numbers, other phrases, etc.

The system may be configured to allow user to save search 703, download search 703, email search 703, etc. The user may also receive mortgage updates via SMS, MMS, email or other appropriate method for receiving mortgage updates. For example, user receives customized updates (e.g., APR trends, lenders information, etc.) once a day, once a week, once a month, etc. The user may receive updates based on when interest rates drop below a certain percentage. Mortgage updates may be customized and/or personalized by user, company etc.

FIG. 7B is an example of a user interface 710 comparing product content. The user may select a number of lenders to compare within the interface configured to receive attributes for the search 703. For example, user may select lender 1 and lender 2 from FIG. 7A to compare 702a or clear the selections 702b. As shown in FIG. 7B, if user selects to compare 702a, then a side-by-side comparison is performed of lenders 1 and lenders 2. In some implementations, more than two lenders may be compared.

FIG. 7C is an example of a user interface 720 providing an overview of mortgages. In some implementations, user selects refinance 721 or new home loan 723, which will direct the user to interface 601, with the appropriate search 703 and display 701 corresponding to refinance 721 or new home loan 723.

FIG. 7C also provides rates for refinancing, new home loans, etc. In FIG. 7C, the rates may be based on previous searches by user, previous searches by other users, etc. For example, for refinance rates, a typical search by a user includes the following attributes for search 703: $200,000 home with a mortgage of $105,000. Interface 720 displays loan terms of 5/1 ARM, 15-year fixed, 30-year fixed, etc. with regard to those attributes. For each loan term, the monthly payment, lowest APR, average APR this week, average APR last week, rates over three months, etc. are provided.

FIG. 7C may also provide a mortgage interest rate trend graph 725. Mortgage interest rate trend graph 725 may display interest rates for refinance, new home loan, etc. Mortgage interest rate trend may display loan type. For example, FIG. 7C includes 3/1 ARM, 5/1 ARM, 15-year fixed, and 30-year fixed as loan types.

In FIG. 7C, interest rates for refinance with a loan type of 30 year fixed and a loan type of 5/1 arm are displayed by trend graph 725. Trend graph 725 may allow user to scroll over the loan type(s) simultaneously. For example, in FIG. 7C, trend graph 725 displays interest rates on Sep. 14, 2011 for 5/1 ARM and 30 year fixed. Each loan type may be color-coded, highlighted, etc. to differentiate it from the other loan types. For example, the 5/1 ARM line and corresponding interest rate may be displayed in green, while the 30-year fixed line and corresponding interest rate may be displayed in pink.

FIG. 7C may also include an option to select a time period for viewing the trend graph 725. For example, in FIG. 7C, interest rate data for 5/1 ARM and 30-year fixed is displayed for three months. Other time periods may include one day, five days, one month, six months, one year, maximum (e.g., user-defined), etc.

Trend graph 725 may also include feature 727. In some implementations, feature 727 may highlight a time period by overlaying the highlighted time period over a maximum unhighlighted time period (e.g., 1 year.) For example, in FIG. 7C, trend graph 725 displays a three month time period. Feature 727 highlights the three month time period, but also displays a greater time period, e.g., a year. In some implementations, feature 727 is an average of the interest rates for the selected loan types. In some implementations, feature 727 may be a zoom function. For example, the left and right lines of feature 727 may be configured on the portion of the graph to zoom the main graph to only include some of the data so that the data graphed in the subfeature is identical to the data in the main portion of the graph above.

FIG. 8A illustrates an example user interface 603 in accordance with a described implementation. User interface 603 provides various product content including credit cards. In some implementations, user interface 603 includes other product content. For example, user interface 603 may include product content related to airlines/rewards programs. User interface 603 may be customized and/or personalized by the user.

In FIG. 8A, user interface 603 is an example of a display showing credit card data 801b and related attributes. In some implementations, credit cards may also include debit cards or other type of financial currency. User interface 603 provides display 801. Display 801 may be based on previous searches by user, previous searches by other users, etc.

As shown in FIG. 8A, display 801 includes an organization of provider/credit card 801a along with related attributes for each provider/credit card. The related attributes may include introductory purchase APR 801b, ongoing purchase APR 801c, annual fee 801d, and reward type 801e. Display 801 may be sorted by attributes 801a-801e. For example, display 801 may be sorted from highest to lowest introductory purchase APR 801b, lowest to highest annual fee 801d, etc. Each parameter 801a-801e may include a hyperlink. The hyperlink may include additional information (e.g., definitions, reference material, external websites, etc.), an action (e.g., contact a lenders, etc.), etc.

In FIG. 8A, Cyti Diamond Card, Cyti Platinum Card, and Dyscover Card are displayed as an example. In some implementations, the provider/card may be selected to obtain more information. For example, information may include hyperlinks to terms and conditions, to an application form, to provider/card website, etc.

In some implementations, information may include card summary. Card summary may include rates and fees, such as introductory purchase APR, purchase APR, introductory balance transfer rate, balance transfer rate, annual fee, etc. In some implementations, card summary may include eligibility, such as minimum credit history, minimum age, existing customer, etc.

In other implementations, information may include purchase APR. Purchase APR may include introductory rate, rate, credit limit, etc. In some implementations, information may include balance transfer. Balance transfer may include introductory rate, introductory rate duration (after credit card is opened), introductory balance transfer fee, introductory balance transfer period, standard balance transfer rate, standard balance transfer fee, balance transfer limit, etc.

In some implementations, information may include cash advances. Cash advances may include introductory rate, cash advance rate, cash advance fee, cash advance limit, etc. In some implementations, information may include account fees and charges. Account fees and charges may include annual fee, initial setup and processing fee, foreign currency transactions, copies of statements, additional cardholder fees, etc.

In some implementations, information may include insurance and protection. Insurance and protection may include car rental insurance, emergency support, flight insurance, lost luggage insurance, travel insurance, extended warranty, fraud liability, etc. In some implementations, information may include penalty fees and charges. Penalty fees and charges include late payment fee, over-limit fee, returned payment fee, minimum interest charge, grace period, default payment rate, etc.

As shown in FIG. 8A, display 801 may be based on a current search by user, as illustrated by interface 803 configured to receive attributes for the current search 803. For example, in FIG. 8A, user may enter card type, e.g., balance transfer, purchase APR, or rewards. User may enter reward type (e.g., cash back, air miles, points, etc.)

The system may be configured to receive card details from a user. For example, user enters purpose of the card (e.g., personal, business, student, etc.) User may enter details regarding what cards to display, e.g., cards with no annual fee, cards with no annual fee for first year, charge cards, etc. User may select network of providers/issuers of credit cards.

The system may be configured to receive a credit rating (e.g., excellent, very good, good, average, limited, fair, poor, etc.) from a user. The credit rating may include ranges associated with each rating. These ranges may be adjusted based on current standards for credit rating. Alternatively, user may enter credit rating by entering numbers, other phrases, etc.

The system may be configured to allow user to save search 803, download search 803 to a spreadsheet, email search 803, etc. User may also receive credit card updates via SMS, MMS, email or other appropriate method for receiving credit card updates. For example, user receives customized updates (e.g., credit card type, rewards, etc.) once a day, once a week, once a month, etc. Credit card updates may be personalized by user(s), etc.

FIG. 8B is an example of user interface 810 comparing product content. The user may select a number of providers/cards to compare within the interface configured to receive attributes for the search 803. For example, user may select Cyti Diamond Card and Dyscover Card from FIG. 8A to compare 802a or clear the selections 802b. As shown in FIG. 8B, if user selects to compare 802a, then a side-by-side comparison is performed of card 1 and card 2. In some implementations, more than two providers/cards may be compared.

FIG. 8C is an example user interface 820 providing an overview of credit cards. In some implementations, user selects balance transfer 821, introductory purchase APR 823, cashback 825, air miles 827, or points 829, which may direct user to interface 603, with the appropriate search 803 and display 801 corresponding to balance transfer 821, introductory purchase APR 823, cashback 825, air miles 827, or points 829.

FIG. 9A illustrates example user interface 605 in accordance with a described implementation. User interface 605 provides various product content including certificates of deposit (CDs). In some implementations, user interface 605 includes other product content. For example, user interface 605 may include product content related to savings bonds or other financial instruments. User interface 605 may be customized and/or personalized by the user.

In FIG. 9A, user interface 605 is an example of a display showing CD data 901c and related attributes. User interface 605 provides display 901. Display 901 may be based on previous searches by user, previous searches by other users, previous searches by the system, etc.

As shown in FIG. 9A, display 901 includes an organization of lenders 901a along with related attributes for each lenders. The related attributes may include APY 901b, term length 901c, minimum to open 901d, interest earned 901e, and early withdrawal penalty 901f. Display 901 may be sorted by attributes 901a-901f. For example, display 901 may be sorted from highest to lowest APY 901b, highest to lowest term length 901c, etc.

In FIG. 9A, ABC Bank, XYZ Bank, Vic Bank are displayed as an example. User may select ABC Bank for additional information. Additional information may include issuer name, APY, compounding rate, rate structure, term, interest earned, account structure, interest payment options, locations of issuer, automatic CD renewal, insurance, early withdrawal fees, renewal grace period, renewal details, etc.

As shown in FIG. 9A, display 901 may be based on a current search 903 by user. The user may change display 401 via an interface configured to receive attributes for search 903. In some implementations, the user may enter CD details. For example, in FIG. 9A, the user may enter amount of CD, maximum term of CD (e.g., 3 month, 6 month, 12 month, 18 month, 3 year, 5 year, etc.), and account type (e.g., regular, IRA, etc.) The user may enter lender details. For example, in FIG. 9A, user may enter zip code to locate lenders with locations within a specified distance of the zip code. In FIG. 9A, user may select the bank via drop-down menu.

The system may be configured to allow the user to save search 903, download search 903, email search 903, etc. The user may also receive CD updates via SMS, MMS, email or other appropriate method for receiving CD updates. For example, the user may receive customized updates (e.g., APY, lenders information, other attributes entered, etc.) once a day, once a week, once a month, etc. CD updates may be customized and/or personalized by user, company, etc.

FIG. 9B is an example of user interface 910 comparing product content. The user may select product content to compare within the interface configured to receive attributes for the search 903. For example, in FIG. 9B, the user selects ABC Bank and Vic Bank from FIG. 9A to compare. In some implementations, more than two lenders may be compared.

FIG. 9C is an example of user interface 920 providing an overview of CDs 901c. In some implementations, user selects short term 921 or long term 923, which may direct user to interface 900, with appropriate search 903 and display 901 corresponding to short term 921 or long term 923.

FIG. 9C also provides CD rates, highest APY CDs, etc. In FIG. 9C, CD rates, highest APY CDs, etc. may be based previous searches by user, previous searches by other users, current/real time searches by user(s), etc. With regard to CD rates, interface 920 displays CD terms of 6 months, 1 year, 5 years, etc. For each CD term, highest APY, average APY this week, average APY last week, rates over three months, etc. are provided.

FIG. 9C may also provide a CD interest rate trend graph 925. CD interest rate trend graph 925 may display interest rates for CD terms, including, but not limited to, 3 month, 6 month, 12 month, 18 month, 3 year and 5 year.

In FIG. 9C, interest rates for CD terms of 12 months and 18 months are displayed by trend graph 925. Trend graph 925 may allow user to scroll over the CD term(s) simultaneously. For example, in FIG. 9C, trend graph 925 displays interest rates on Nov. 15, 2011 for both 12 month CD terms and 18 month CD terms. Each CD term may be color-coded, highlighted, etc. to differentiate it from the other CD terms. For example, the 18-month CD term line and corresponding interest rate may be displayed in purpose, while the 12 month line and corresponding interest rate may be displayed in yellow.

FIG. 9C may also include an option to select a time period for viewing the trend graph 925. For example, in FIG. 9C, interest rate data for 12 month and 18 month CDs is displayed for a time period of 3 months. Other time periods may include one day, five days, one month, six months, one year, maximum (e.g., user-defined), etc.

Trend graph 925 may also include feature 927. In some implementations, feature 927 may highlight a time period by overlaying the highlighted time period over a maximum unhighlighted time period (e.g., 1 year.) For example, in FIG. 9C, trend graph 925 displays a three month time period. Feature 927 highlights the three month time period, but also displays a greater time period, e.g., a year. In some implementations, feature 927 is an average of the interest rates for the selected loan types. In some implementations, feature 927 may be a zoom function. For example, the left and right lines of feature 927 may be configured on the portion of the graph to zoom the main graph to only include some of the data so that the data graphed in the subfeature is identical to the data in the main portion of the graph above.

FIG. 10A is an example of user interface 607 in accordance with a described implementation. User interface 607 provides various product content including checking accounts. In some implementations, user interface 607 includes other product content. For example, user interface 607 may include product content related to trust accounts, escrow accounts, etc. User interface 607 may be customized and/or personalized by user(s).

In FIG. 10A, user interface 607 is an example of a display showing checking account data and related attributes. User interface 607 provides display 1001. Display 1001 may be based on previous searches by user, previous searches by other users, etc.

As shown in FIG. 10A, display 1001 includes an organization of lenders 1001a along with related attributes for each lenders. The related attributes include, but are not limited to, APY 1001b, minimum to open 1001c, monthly fee 1001d, details 1001e. Display 1001 may be sorted by attributes 1001a-1001e. For example, display 1001 may be sorted from highest to lowest APY, highest to lowest monthly fee, etc.

Each parameter 1001a-1001e may include a hyperlink. The hyperlink may include additional information (e.g., definitions, reference material, external websites, etc.), an action (e.g., contact a lenders), etc.

In FIG. 10A, ABC Bank-Rewards Checking, XYZ Bank-Online Checking, and Vic Bank-Checking are displayed as an example. In some implementations, the lenders may be selected to obtain more information. For example, information may include hyperlinks to terms and conditions, to an application form, to lenders website, etc.

In some implementations, information may include basic information. Basic information may include issuer, account type, minimum to open, interest rate, transaction at bank owned ATMs, transaction at non-bank owned ATMs, ATM fee reimbursement details, insurance, etc.

In some implementations, information may include basic fees. Basic fees may include account fees, account fee waiver, overdraft, returned item (not sufficient funds), stop payment, etc.

As shown in FIG. 10A, display 1001 may be based on a current search 1003 by user. For example, in FIG. 10A, user may enter account details. Account details may include initial deposit. User may enter details regarding what checking accounts to display, e.g., accounts with no monthly fee, interest checking accounts, etc. User may enter lenders details. For example, in FIG. 10A, user may enter zip code to locate lenders with locations within a specified distance of the zip code. In FIG. 10A, user may select the lenders via drop-down menu.

User may save search 1003, download search 1003, email search 1003, etc. The user may also receive checking account updates via SMS, MMS, email or other appropriate method for receiving checking account updates. For example, user may receive customized updates (e.g., based on APY or other appropriate attributes) once a day, once a week, once a month, etc. Checking account updates may be customized and/or personalized by user.

FIG. 10B is an example of user interface 1010 comparing multiple checking accounts. User may select a number of lenders/checking accounts within search 1003 to compare. For example, user may select ABC Bank-Rewards Checking and Vic Bank-Checking to compare 1002a or clear the selections 1002b. As shown in FIG. 10B, if user selects to compare 1002a, then a side-by-side comparison is performed of ABC Bank-Rewards Checking and Vic Bank-Checking. In some implementations, more than two lenders/checking accounts may be compared.

FIG. 10C is an example user interface 1020 providing an overview of checking accounts. In some implementations, user selects local checking accounts 1021 or highest interest rate 1023, which may direct user to interface 607, with the appropriate search 1003 and display 1001 corresponding to local checking accounts 1021 or highest interest rate 1023.

FIG. 11A is an example of user interface 609 in accordance with a described implementation. User interface 609 provides various product content including savings accounts. In some implementations, user interface 609 includes other product content. For example, user interface 609 may include product content related to trust accounts, escrow accounts, etc. User interface 609 may be customized and/or personalized by user(s).

In FIG. 11A, user interface 609 is an example of savings accounts and related attributes. User interface 609 provides display 1101. Display 1101 may be based on previous searches by user, previous searches by other users, etc.

As shown in FIG. 11A, display 1101 includes an organization of lenders 1101a along with related attributes for each lenders. The related attributes include, but are not limited to, APY 1101b, minimum to open 1101c, monthly fee 1101d, interest earned 1101e, and details 1101f. Display 1101 may be sorted by attributes 1101a-1101e. For example, display 1101 may be sorted from highest to lowest APY, highest to lowest monthly fee, etc.

Each parameter 1101a-1101e may include a hyperlink. The hyperlink may include additional information (e.g., definitions, reference material, external websites, etc.), an action (e.g., contact a lenders), etc.

In FIG. 11A, ABC Bank-Rewards Savings, XYZ Bank-Online Savings, and Vic Bank-Savings are displayed as an example. In some implementations, the lenders may be selected to obtain more information. For example, information may include hyperlinks to terms and conditions, to an application form, to lenders website, etc.

In some implementations, information may include basic information. Basic information may include issuer, account type, minimum to open, interest rate, transaction at bank owned ATMs, transaction at non-bank owned ATMs, ATM fee reimbursement details, insurance, etc.

In some implementations, information may include basic fees. Basic fees may include account fees, account fee waiver, overdraft, returned item (not sufficient funds), stop payment, etc.

As shown in FIG. 11A, display 1101 may be based on a current search 1103 by user. For example, in FIG. 11A, user may enter account details. Account details may include initial deposit. User may enter details regarding what savings accounts to display, e.g., regular savings accounts, money market savings accounts, etc. User may enter lenders details. For example, in FIG. 11A, user may enter zip code to locate lenders with locations within a specified distance of the zip code. In FIG. 11A, user may select the lenders via drop-down menu.

User may save search 1103, download search 1103, email search 1103, etc. The user may also receive savings account updates via SMS, MMS, email or other appropriate method for receiving savings account updates. For example, user may receive customized updates (e.g., based on APY or other appropriate attributes) once a day, once a week, once a month, etc. Savings account updates may be customized and/or personalized by user.

FIG. 11B is an example of user interface 1110 comparing multiple savings accounts. User may select a number of lenders/savings accounts within search 1103 to compare. For example, user may select ABC Bank-Rewards Savings and Vic Bank-Savings to compare 1102a or clear the selections 1102b. As shown in FIG. 11B, if user selects to compare 1102a, then a side-by-side comparison is performed of ABC Bank-Rewards Savings and Vic Bank-Savings. In some implementations, more than two lenders/savings accounts may be compared.

FIG. 11C is an example user interface 1120 providing an overview of savings accounts. In some implementations, user selects local savings accounts 1121 or highest interest rate 1123, which may direct user to interface 609, with the appropriate search 1103 and display 1101 corresponding to local savings accounts 1121 or highest interest rate 1123.

The implementations described herein accurately aggregate values for efficient retrieval. Other websites and other product search engines that are tracking non-uniform pricing (for example, sites that track prices offered for computer components from different vendors) may implement the described implementations. Outside of advertising and commerce, the techniques described herein may be applied to analyze large data sets. For example, census data from various years could be analyzed using the described implementations to generate meaningful trends graphs over that data set in a variety of ways.

The system may be capable of handling any value, any time period, and any statistic. Although the example implementations are shown to be financial products where values are generated on a daily interval (e.g., best and mean interest rates), the system may also be implemented to generate values, statistics (e.g., median or rolling averages on a weekly basis), for different product types, for example to track trends for price of automobiles.

FIG. 12 is a block diagram of a computing device 1200 that may be used to implement the systems and methods in accordance with the described implementations, as either a client or as a server or plurality of servers. Computing device 1200 may include, but is not limited to, digital computers, such as laptops, desktops, workstations, personal digital assistants, servers, blade servers, mainframes, cellular telephones, smartphones, mobile computing devices (e.g., a notepad, e-reader, etc.) etc.

Computing device 1200 includes a processor 1202, memory 1204, an interface 1206 and ports 1208. Each of the components 1202, 1204, 1206, and 1208, are interconnected using various busses, and may be mounted on a common motherboard or in other manners as appropriate. The processor 1202 can process instructions for execution within the computing device 1200, including instructions stored in the memory 1204 to display graphical information for a GUI on an external input/output device, such as display 1210 coupled to interface 1208. In other implementations, multiple processors and/or multiple buses may be used, as appropriate, along with multiple memories and types of memory. Also, multiple computing devices 1200 may be connected, with each device providing portions of the necessary operations (e.g., as a server bank, a group of blade servers, a multi-processor system, etc.). The ports 1208, which may include various communication ports (e.g., USB, Bluetooth, Ethernet, wireless Ethernet, etc.), may be coupled to an input/output device, such as a keyboard, a mouse, a pointing device, a scanner, etc., or a networking device (a switch, adapter, bridge, router, hub, repeater, etc.).

The processor 1202 may provide, for example, for coordination of the other components of the device 1200, such as control of user interfaces, applications run by device 1200, and wireless communication by device 1200. Processor 1202 may communicate with a user via interface 1206 (e.g., control, display, external, etc.), coupled to a display 1210. The display 1210 may be, for example, a TFT (Thin-Film-Transistor Liquid Crystal Display) display, an OLED (Organic Light Emitting Diode) display, other flexible display, etc. The interface 1206 may include circuitry for driving the display 1210 to provide graphical, textual, and other information to a user. The interface 1206 may receive commands (e.g., voice-activated, text, etc.), from a user and convert them to provide to the processor 1202. In addition, the interface 1206 may be provided to communicate with processor 1202 and enable near area communication of device 1200 with other devices. The interface 1206 may provide, for example, for wired communication. In some implementations, multiple interfaces may be used. Computing device 1200 may communicate wirelessly through interface 1206, which may include digital signal processing circuitry where necessary. Interface 1206 may provide for communications under various modes or protocols, such as GSM voice calls, SMS, EMS, or MMS messaging, CDMA, TDMA, PDC, WCDMA, CDMA2000, or GPRS, etc. Such communication may occur, for example, through a radio-frequency transceiver. In addition, short-range communication may occur, such as using a Bluetooth, WiFi, or other such transceiver. In addition, GPS (Global Positioning System) receiver module may provide additional navigation- and location-related wireless data to device 1200, which may be used as appropriate by applications running on device 1200. The device 1200 may also be provided with a storage device to provide additional storage, e.g., solid-state flash media. Each of the components may be interconnected using various buses. Several of the components may be mounted on a common motherboard or in other appropriate manners.

Device 1200 may communicate audio feedback. In some implementations, an audio codec may receive spoken information from a user and convert it to usable digital information. The audio codec may generate audible sound for a user, such as through a speaker, e.g., in a handset of device. Sound(s) may include sound from voice telephone calls, recorded sound (e.g., voice messages, music files, etc.), sound(s) generated by applications operating on device, etc.

The memory 1204 stores information within the computing device 1200. In one implementation, the memory 1204 is a volatile memory unit or units. In another implementation, the memory 1204 is a non-volatile memory unit or units. The memory 1204 may also be another form of computer-readable medium, such as a magnetic or optical disk. The memory 1204 may be capable of providing mass storage for the computing device 1200. In one implementation, the memory 1204 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform a method, such as those described above. The information carrier is a computer or machine-readable medium, such as the memory 1204, memory on processor 1202, a propagated signal, etc. Expansion memory may be provided and connected to device 1200 through interface 1206.

These computer programs (e.g., programs, software, software applications or code), include machine instructions for a programmable processor, and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Controllers (PLCs) Programmable Logic Devices (PLDs)), used to provide machine instructions and/or data to a programmable processor.

To provide for interaction with a user, the systems and techniques described here can be implemented on a computer having a display device (e.g., a CRT (cathode ray tube) or LCD (liquid crystal display) monitor), for displaying information to the user and a keyboard and a pointing device (e.g., a mouse or a trackball), by which the user can provide input to the computer. Other kinds of devices can be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Various implementations of the systems and techniques described here can be realized using one or more processing circuits, modules, or devices comprising one or more of digital electronic circuitry, integrated circuitry, specially designed ASICs (application specific integrated circuits), computer hardware, firmware, software, and/or combinations thereof. These various implementations can include implementation in a computer program that is executable and/or interpretable on a programmable system including at least one programmable processor, which may be special or general purpose, coupled to receive data and instructions from, and to transmit data and instructions to, a storage system, at least one input device, and at least one output device.

The systems ad techniques described here can be implemented in a computing system that includes a back-end component, a middleware component, or a front-end component, or any combination of back-end, middleware, or front-end components. The components of the system may be interconnected by any form or medium of digital data communication (e.g., a communication network). Examples of communication networks include a local area network (“LAN”), a wide area network (“WAN”), and the Internet.

While this specification contains many specific implementation details, these should not be construed as limitations on the scope of any disclosures or of what may be claimed, but rather as descriptions of features specific to particular implementations of particular disclosures. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method comprising:
providing periodically, at a server, a set of queries for product content, wherein the product content comprises a plurality of attributes of a product, the set of queries comprises a pre-defined set of values for a pre-defined set of attributes, and the set of queries provides a representative view of a product space comprising a plurality of product content;
receiving, at the server, a request to sort results from the set of queries based on one of the attributes for each of a plurality of time periods;
generating a plurality of set of results, each set of results based on a respective query of the set of queries and one of the plurality of time periods, each result comprising a set of attribute values;
aggregating, for each query of the set of queries at each one of the plurality of time periods, a set of values from one or more of the plurality of set of results;
storing, periodically, each aggregated set of values in a database;
receiving, at the server, a query criteria and a time range, the query criteria comprising specific attribute values;
matching the query criteria with a query of the set of queries, the matching query comprising the pre-defined set of values that matches the specific attributes values of the query criteria;
retrieving, from the database, a stored set of values to determine trend data relating to the product content, the stored set of values corresponding to the matched query of the set of queries; and
providing display data indicative of the trend data.

2. The method of claim 1, wherein the product content comprises attributes selected from the group consisting of mortgages, credit cards, certificates of deposit, checking accounts and savings accounts.

3. The method of claim 1, wherein receiving a request to sort results further comprises iterating over the set of queries for product content for each of the plurality of time periods.

4. (canceled)

5. (canceled)

6. The method of claim 1, wherein the attributes comprise product content provider information.

7. (canceled)

8. (canceled)

9. (canceled)

10. (canceled)

11. A system for providing trend data comprising:
a non-transitory computer-readable storage device comprising instructions; and a processor coupled to the non-transitory computer-readable storage device and configured to execute the instructions to perform operations comprising:
providing periodically, at a server, a set of queries for product content, wherein the product content comprises a plurality of attributes of a product, the set of queries comprises a pre-defined set of values for a pre-defined set of attributes, and the set of queries provides a representative view of a product space comprising a plurality of product content;
receiving, at the server, a request to sort results from the set of queries based on one of the attributes for each of a plurality of time periods;
generating a plurality of set of results, each set of results based on a respective query of the set of queries and one of the plurality of time periods, each result comprising a set of attribute values;
aggregating, for each query of the set of queries at each one of the plurality of time periods, a set of values from one or more of the plurality of set of results;
storing, periodically, each aggregated set of values in a database;
receiving, at the server, a query criteria and a time range, the query criteria comprising specific attribute values;
matching the query criteria with a query of the set of queries, the matching query comprising the pre-defined set of values that matches the specific attributes values of the query criteria;
retrieving, from the database, a stored set of values to determine trend data relating to the product content, the stored set of values corresponding to the matched query of the set of queries; and
providing display data indicative of the trend data.

12. The system of claim 11, wherein the product content comprises attributes selected from the group consisting of mortgages, credit cards, certificate of deposits, checking accounts and savings accounts.

13. The system of claim 11, wherein receiving a request to sort results further comprises iterating over the set of queries for product content for each of the plurality of time periods.

14. (canceled)

15. (canceled)

16. The system of claim 11, wherein the attributes comprise product content provider information.

17. (canceled)

18. (canceled)

19. A non-transitory machine-readable storage medium having recorded and stored thereon instructions that, when executed, performs actions comprising:
providing periodically, at a server, a set of queries for product content, wherein the product content comprises a plurality of attributes of a product, the set of queries comprises a pre-defined set of values for a pre-defined set of attributes, and the set of queries provides a representative view of a product space comprising a plurality of product content;
receiving, at the server, a request to sort results from the set of queries based on one of the attributes for each of a plurality of time periods;
generating a plurality of set of results, each set of results based on a respective query of the set of queries and one of the plurality of time periods, each result comprising a set of attribute values;
aggregating, for each query of the set of queries at each one of the plurality of time periods, a set of values from one or more of the plurality of set of results;
storing, periodically, each aggregated set of values in a database;
receiving, at the server, a query criteria and a time range, the query criteria comprising specific attribute values;
matching the query criteria with a query of the set of queries, the matching query comprising the pre-defined set of values that matches the specific attributes values of the query criteria;
retrieving, from the database, a stored set of values to determine trend data relating to the product content, the stored set of values corresponding to the matched query of the set of queries; and
providing display data indicative of the trend data.

20. The medium of claim 19, wherein the product content comprises attributes selected from the group consisting of mortgages, credit cards, certificates of deposit, checking accounts and savings accounts.

21. The medium of claim 19, wherein receiving a request to sort results further comprises iterating over the set of queries for product content for each of the plurality of time periods.

22. The medium of claim 19, wherein the attributes comprise product content provider information.

23. (canceled)

24. (canceled)
